(19) United States
(12) Patent Application Publication
(10) Pub. No.: US 2009/0268264 A1
(43) Pub. Date: Oct. 29, 2009

(54) IMAGE PROCESSING APPARATUS, IMAGE SCANNING APPARATUS, AND IMAGE PROCESSING METHOD

(75) Inventor: Katsushi MINAMINO, Kyoto-shi (JP)

Correspondence Address: MURATA MACHINERY, LTD.;(MURATEC) c/o KEATING & BENNETT LLP, 1800 Alexander Bell Drive, SUITE 200, Reston, VA, 20191, US

(73) Assignee: MURATA MACHINERY, LTD., Kyoto-shi (JP)

(21) Appl. No.: 12/400,110

(22) Filed: Mar. 9, 2009

(30) Foreign Application Priority Data
Apr. 23, 2008 (JP) 2008-113193

(51) Int. Cl. H04N 1/04; G06K 9/46

(52) U.S. Cl. 358/474; 382/201

(57) ABSTRACT

An image scanner apparatus includes an automatic image acquiring unit having a feature point detecting unit, an inclination calculating unit, a feature point rotation calculating unit, and a rectangular area calculating unit. The feature point detecting unit is arranged to detect a plurality of feature points of an original document outline from image data acquired by scanning an original document. The inclination calculating unit is arranged to calculate values regarding an original document inclination. The feature point rotation calculating unit is arranged to calculate positions of rotated feature points acquired by rotating the plurality of feature points detected through the feature point detecting unit around a prescribed center point by an inclination angle in a direction in which the original document inclination is corrected. The rectangular area calculating unit is arranged to calculate a non-inclined rectangular area having an outline that is disposed in the vicinity of the rotated feature points based on the positions of the rotated feature points.

### CROSS-REFERENCE TO RELATED APPLICATIONS

This application claims priority under 35 U.S.C. 119 to Japanese Patent Application No. 2008-113193, filed on Apr. 23, 2008, which application is hereby incorporated by reference in its entirety.

### BACKGROUND OF THE INVENTION

1. Field of the Invention

The present invention primarily relates to an image processing apparatus that automatically detects a prescribed area including a portion of an original document and considers an original document inclination based on image data acquired by scanning the original document.

2. Description of the Related Art

In a known image scanner apparatus, for example, a copier, a facsimile machine, and an Optical Character Reader (OCR), or other similar image scanning apparatuses, when an original document is scanned in an inclined state, an inclined image is acquired, thereby deteriorating the scanning quality. In order to prevent such a deterioration, an image scanning apparatus that includes an image processing apparatus arranged to automatically detect an inclination angle of an original document by analyzing image data and that can electronically correct the inclination by rotating the image data based on the acquired inclination angle has been disclosed.

For example, a known image processing apparatus includes an original document detection unit, an image correction unit, and an image clipping unit. When an original document is placed on a platen, the original document detection unit detects a size of the original document through a photo sensor or other similar devices. The image correction unit then detects a displacement or an inclination with respect to a reference position of an original document image included in a scanned image and corrects the displacement or the inclination. The image clipping unit clips the image corrected through the image correction unit to the size of the original document. With such a configuration, the image of the entire original document can be properly corrected.

In the above-described image processing apparatus, the image correction unit calculates an amount of inclination and an amount of displacement with respect to the reference position of the original document based on image data. In view of the calculation of the inclination amount, for example, a known inclination extraction device includes a pixel position detection unit, a local minimum point extraction unit, and an inclination extraction unit. The pixel position detection unit is arranged to detect, with respect to each scanning line, a position of a character pattern leading edge pixel detected at a prescribed number sequentially counted on the corresponding scanning line by scanning the acquired image data in one direction. The local minimum point extraction unit is arranged to extract a position of a local minimum pixel from the leading edge pixels each detected on the corresponding scanning line. The inclination extraction unit is arranged to extract an inclination of an information medium based on the position of the extracted local minimum pixel. In this inclination extraction device, an inclination extracting process can be performed at high speed with the above-described configuration.

However, in the configuration of such an image processing apparatus, because a clipping process is performed after the inclination amount and the displacement amount are corrected, an inclination and displacement correcting process is performed on an area to be clipped and also on other areas, which thereby reduce the speed of the process.

However, in the inclination extraction device, when an original document having an inclined text due to its design is scanned, or when an original document having a slant line is scanned, for example, even if such original documents are properly positioned, an inclination is incorrectly detected at the time of scanning, and the image data may be unintentionally rotated. Therefore, an image processing apparatus that can properly correct the inclination regardless of the content of an original document is desirable. Moreover, when the original document is not in good condition, such as when a corner portion of the original document is dog-eared, torn, curled up, twisted, or wrinkled, for example, it is difficult to position these types of documents accurately along an original document guide. Therefore, an image processing apparatus has been desired that can properly correct the inclination and clip areas even in the above-described cases.

### SUMMARY OF THE INVENTION

Preferred embodiments of the present invention provide a solution to the above described problems. Now, methods and their advantages in overcoming such problems will be described.

According to a first preferred embodiment of the present invention, an image processing apparatus includes a feature point detecting unit, an inclination calculating unit, a feature point rotation calculating unit, and a rectangular area calculating unit. The feature point detecting unit is arranged to detect a plurality of feature points of an original document outline from image data acquired by scanning an original document. The inclination calculating unit is arranged to calculate values regarding an original document inclination. The feature point rotation calculating unit is arranged to calculate positions of rotated feature points, which are acquired by rotating the plurality of feature points detected through the feature point detecting unit around a prescribed center point by an inclination angle in a direction in which the original document inclination is corrected. The rectangular area calculating unit is arranged to calculate, based on the positions of the rotated feature points, a non-inclined rectangular area having an outline that is disposed in the vicinity of the rotated feature points.

In the above-described configuration, based on a shape and an inclination of an original document portion of the image data, a rectangular area including the original document portion in the case where the original document inclination is corrected can be properly determined. Moreover, the rectangular area can be properly determined since the rectangular area is determined from the feature points of the original document outline, even when the original document has various shapes, such as a non-square shape. Furthermore, the rectangular area of the original document portion can be determined only from the positions of the rotated feature points, without performing a rotation process on the entire image data. Therefore, the calculation cost and the period of time required for the processes can be effectively reduced. Furthermore, since the rectangular area is acquired in a non-inclined state, the data can be easily handled, and the calculation process can be simplified.

In the above-described image processing apparatus, the feature points preferably include points, at least one of the points being individually disposed on each of four sides of the original document outline.

In the above configuration, the rectangular area including the original document portion can be easily calculated and determined from the positions of the detected feature points.

In the above-described image processing apparatus, the feature point detecting unit preferably detects a parallel or substantially parallel line from the original document outline, and then acquires the feature points based on a detection result.

In the above-described configuration, the feature points can be calculated through a simple process.

In the above-described image processing apparatus, the inclination calculating unit preferably calculates the values regarding the original document inclination based on the positions of at least two feature points selected from the feature points detected through the feature point detecting unit.

In the above-described configuration, the feature points can also be used in the inclination detection, which thereby improves efficiency of the processes and increases the speed of the processes.

In the above-described image processing apparatus, it is preferable to provide a size information determining unit arranged to determine size information based on a size of the rectangular area.

In the above-described configuration, a size with which the area including the original document portion is extracted from the image data can be properly and automatically determined. Moreover, the image data can be used as print data, and thus, another process is not required at the time of printing.

In the above-described image processing apparatus, the size information determining unit preferably determines the size information by selecting, from a plurality of predetermined format sizes, a format size that is the closest in size to the size of the rectangular area.

In the above-described configuration, for example, the area including the original document portion can be extracted from the image data in accordance with a commonly-used format size, which is convenient. Moreover, since the format size that is the closest in size to the rectangular area is selected, a proper format size can be selected in view of the size of the original document portion. Further, even if a slight error occurs in the position or the like of the calculated feature point, the size information can be prevented from being influenced by such errors.

In the above-described image processing apparatus, the size information determining unit preferably determines the size information by selecting, from the predetermined format sizes, the smallest format size that can include the rectangular area.

In the above-described configuration, for example, the area including the original document portion can be extracted from the image data in accordance with the commonly-used format size, which is convenient. Moreover, since the smallest format size that can include the rectangular area is selected, a proper size can be selected in view of the size of the original document portion, and the original document portion can be prevented from being cut from the area having the format size.

The above-described image processing apparatus preferably includes a target area determining unit, an extraction area calculating unit, and an extraction rotation process unit. The target area determining unit is arranged to determine a position of the non-inclined rectangular original document target area having a size that corresponds to the size information such that at least one portion of the original document target area overlaps with the rectangular area. The extraction area calculating unit is arranged to calculate the extraction area of the image data by rotating the original document target area around the center point by the inclination angle of the original document. The extraction rotation process unit is arranged to acquire image data that corresponds to the original document target area by extracting a portion of the extraction area from the image data, and then performing a rotation process for correcting the original document inclination.

In the above-described configuration, the original document portion can be extracted in the image data in accordance with a proper size, and then a preferable scan image can be acquired by correcting the original document inclination. Moreover, an inclination correcting process and an extraction process can be easily performed simultaneously.

In the above-described image processing apparatus, the target area determining unit preferably determines the position of the original document target area such that a center of the original document target area matches to a center of the rectangular area.

In the above-described configuration, since the original document portion is disposed at the center position in the acquired image data, the usefulness of the image data can be improved. Moreover, similarly to the rectangular area, since the original document target area is acquired with a non-inclined rectangular shape, the calculation can be simplified, and the processes can be performed at high speed.

In the above-described image processing apparatus, the extraction rotation process unit preferably performs a filling process with a prescribed color on a portion that corresponds to an edge of the rectangular area.

In the above-described configuration, even when an edge of the original document appears in a framed shape at the edge portion of the rectangular area in the image data, the edge can be removed through the filling process, which thereby implements an automatic frame-removing function.

According to a second preferred embodiment of the present invention, an image scanning apparatus includes the above-described image processing apparatus and an image scanning unit arranged to acquire image data by scanning an original document. In the image scanning apparatus, the image data is processed through the image processing apparatus.

In the above-described configuration, based on a shape and an inclination of an original document portion of the image data, a rectangular area including the original document portion in the case where the original document inclination is corrected can be properly determined. Therefore, this preferred embodiment is preferably used in a process of automatically recognizing the size of the original document, for example.

A third preferred embodiment of the present invention provides an image processing program including a feature point detecting step, an inclination calculating step, a feature point rotation calculating step, and a rectangular area calculating step. In the feature point detecting step, a plurality of feature points of an original document outline is detected from image data acquired by scanning an original document. In the inclination calculating step, values regarding an original document inclination are calculated. The feature point rotation calculating step calculates positions of rotated features acquired by rotating the plurality of feature points detected through the feature point detecting unit around a prescribed center point by an inclination angle in a direction in which the original document inclination is corrected. In the rectangular area calculating step a non-inclined rectangular area having an outline that is disposed in the vicinity of the rotated feature points is calculated based on the positions of the rotated feature points.

In the above-described configuration, based on a shape and an inclination of an original document portion of the image data, a rectangular area including the original document portion in the case where the original document inclination is corrected can be properly determined. Moreover, since the rectangular area is determined from the feature points of the original document outline, even when the original document has various shapes, such as a non-square shape, the rectangular area can be properly determined. Further, the rectangular area of the original document portion can be determined only from the positions of the rotated feature points, without performing a rotation process on the entire image data. Therefore, the calculation cost and the period of time required for the processes can be reduced effectively. Furthermore, since the rectangular area is acquired in a non-inclined state, the data can be easily handled, and the calculation process can be simplified.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a front sectional view illustrating an entire configuration of an image scanner apparatus according to a preferred embodiment of the present invention.

FIG. 2 is a block diagram illustrating an electrical configuration of the image scanner apparatus according to a preferred embodiment of the present invention.

FIG. 3 is a flowchart representing a main routine of an inclination detecting process executed through an inclination detecting unit according to a preferred embodiment of the present invention.

FIG. 4 illustrates original document pixels detected from image data according to a preferred embodiment of the present invention.

FIG. 5 is a flowchart of a sub routine in which a leading corner portion of an original document is detected according to a preferred embodiment of the present invention.

FIG. 6 illustrates a process of detecting the leading corner portion of the original document according to a preferred embodiment of the present invention.

FIG. 7 is a flowchart of a sub routine in which a left-hand corner portion of the original document is detected according to a preferred embodiment of the present invention.

FIG. 8 illustrates a process of detecting the left-hand corner portion of the original document according to a preferred embodiment of the present invention.

FIG. 9 is a flowchart of a sub routine in which a parallel side of the original document is detected according to a preferred embodiment of the present invention.

FIG. 10 illustrates a process of detecting the parallel side of the original document according to a preferred embodiment of the present invention.

FIG. 11 is a flowchart of a sub routine in which a trailing corner portion of the original document is detected according to a preferred embodiment of the present invention.

FIG. 12 is an example of feature points of an outline detected with respect to a rectangular original document and an example of the statuses of the feature points according to a preferred embodiment of the present invention.

FIG. 13 is an example of a priority order in which two feature points used for calculating an inclination are selected according to a preferred embodiment of the present invention.

FIG. 14 illustrates an inclination detecting process performed when the left-hand corner portion of the original document is dog-eared and torn according to a preferred embodiment of the present invention.

FIG. 15 illustrates an inclination detecting process performed when the leading corner portion of the original document is substantially dog-eared according to a preferred embodiment of the present invention.

FIG. 16 illustrates an inclination detecting process performed when the original document has a non-square shape according to a preferred embodiment of the present invention.

FIG. 17 is a flowchart representing an extraction area determining process executed through an image extraction determining unit according to a preferred embodiment of the present invention.

FIG. 18 represents a process of determining a rectangular area and an original document target area by rotating the detected feature points by an inclination angle according to a preferred embodiment of the present invention.

FIG. 19 represents a process of calculating the extraction area of image data by rotating the original document target area by the inclination angle according to a preferred embodiment of the present invention.

FIG. 20 illustrates the determined extraction area according to a preferred embodiment of the present invention.

FIG. 21 represents a process of acquiring two inclination integer parameters “a” and “b” from a specified extraction area of the image data according to a preferred embodiment of the present invention.

FIG. 22 is a flowchart representing a rotation process executed through an extraction rotation process unit according to a preferred embodiment of the present invention.

FIG. 23 simply represents the rotation process according to a preferred embodiment of the present invention.

FIG. 24 is a schematic diagram representing a two-dimensional interpolation process according to a preferred embodiment of the present invention.

FIG. 25 illustrates an example of an image of the extraction area according to a preferred embodiment of the present invention and a rotation result thereof.

### DETAILED DESCRIPTION OF PREFERRED EMBODIMENTS

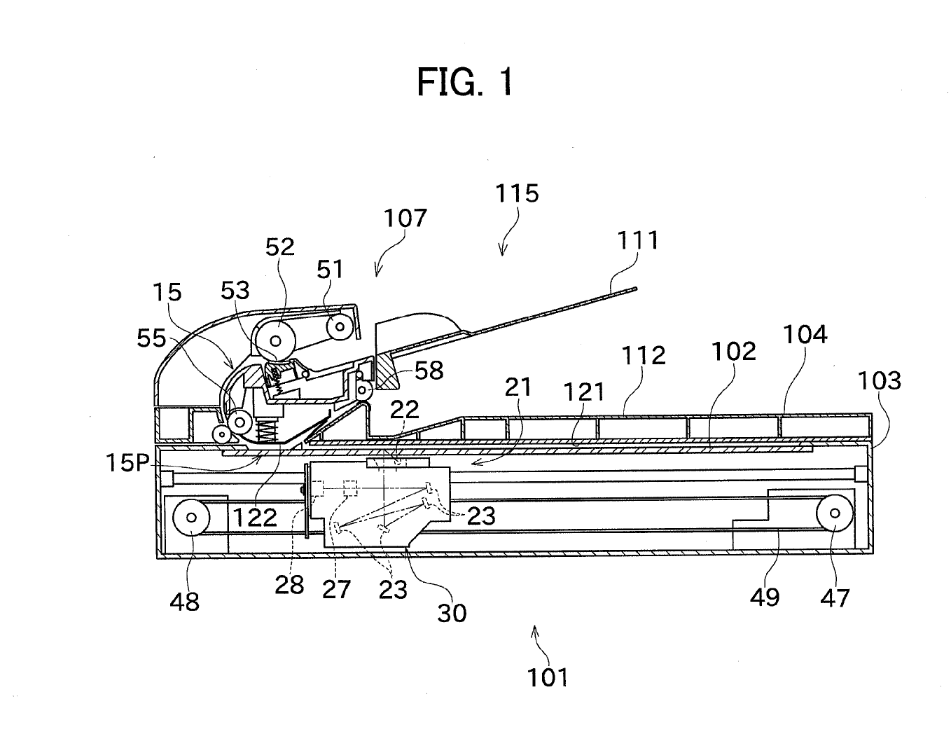

Preferred embodiments of the present invention will now be described. FIG. 1 is a front sectional view illustrating an entire configuration of an image scanner apparatus according to a preferred embodiment of the present invention.

As illustrated in FIG. 1, an image scanner apparatus 101 defining an image scanning apparatus preferably includes an image scanning unit 115 having an Auto Document Feeder (ADF) unit and a flat bed unit.

The image scanning unit 115 preferably includes an original document table 103 having a platen glass 102 on which an original document is placed, and an original document table cover 104 arranged to maintain the original document such that the document is pressed against the platen glass. The image scanner apparatus 101 preferably includes an operation panel (not illustrated) arranged to commence the start of original document scanning or the like. A pressing pad 121 that presses the original document downward is preferably attached to a lower surface of the original document table cover 104 such that the pad 121 opposes the platen glass 102.

The original document table cover 104 preferably includes an ADF 107. The ADF 107 preferably includes an original document tray 111 arranged on an upper portion of the original document table cover 104 and a discharge tray 112 arranged below the original document tray 111.

As illustrated in FIG. 1, a curved original document transportation path 15 that links the original document tray 111 to the discharge tray 112 is preferably arranged inside the original document table cover 104. The original document transportation path 15 preferably includes a pick up roller 51, a separation roller 52, a separation pad 53, a transportation roller 55, and a discharge roller 58.

The pick up roller 51 picks up the original document placed on the original document tray 111. The separation roller 52 and the separation pad 53 separate the picked up original documents one sheet at a time. The transportation roller 55 transports the separated original document to an original document scanning position 15P. The discharge roller 58 discharges the scanned original document onto the discharge tray 112. A pressing member 122 opposing the platen glass is preferably arranged at the original document scanning position 15P.

In the above-described configuration, the original documents stacked and placed on the original document tray 111 are separated one sheet at a time and transported along the curved original document transportation path 15. Then, after the original document passes through the original document scanning position 15P and is scanned through a scanner unit 21, which will be described below, the document is discharged onto the discharge tray 112.

As illustrated in FIG. 1, the scanner unit 21 is preferably arranged inside the original document table 103. The scanner unit 21 preferably includes a carriage 30 that can move inside the original document table 103.

The carriage 30 preferably includes a lamp 22 as a light source, reflection mirrors 23, a condenser lens 27, and a Charge Coupled Device (CCD) 28. The lamp 22 preferably irradiates the original document with light. After the light reflected from the original document is reflected by the plurality of reflection mirrors 23, the light passes through the condenser lens 27, converges, and forms an image on a front surface of the CCD 28. The CCD 28 preferably converts the converged light into an electrical signal and outputs the signal.

In the present preferred embodiment, a 3-line color CCD is preferably used as the CCD 28. The CCD 28 preferably includes a one-dimensional line sensor with respect to each color of Red, Green, and Blue (RGB). Each of the line sensors extends in a main scanning direction (i.e., a width direction of an original document). The CCD 28 also preferably includes different color filters that correspond to the respective line sensors.

A driving pulley 47 and a driven pulley 48 are preferably supported rotationally inside the original document table 103. An endless drive belt 49 is preferably arranged between the driving pulley 47 and the driven pulley 48 in a tensioned state. The carriage 30 is preferably fixed to a proper position of the drive belt 49. In this configuration, by driving the driving pulley 47 in a forward and rearward direction by using an electric motor (not illustrated), the carriage 30 can travel horizontally along a sub scanning direction.

In this configuration, when the carriage 30 is moved in advance to a position that corresponds to the original document scanning position 15P, the ADF 107 is driven. Then, the original document to be transported in the original document transportation path 15 is scanned at the original document scanning position 15P. The reflection light, which is radiated from the lamp 22 and reflected by the original document, is introduced into the carriage 30, directed to the CCD 28 by the reflection mirrors 23 via the condenser lens 27, and forms an image. Thus, the CCD 28 can output an electrical signal that corresponds to the scanned content.

When using the flat bed unit, while the carriage 30 is moved at a prescribed speed along the platen glass 102, an original document placed on the platen glass 102 can be scanned. Reflected light from the original document is similarly introduced into the CCD 28 of the carriage 30 and forms an image.

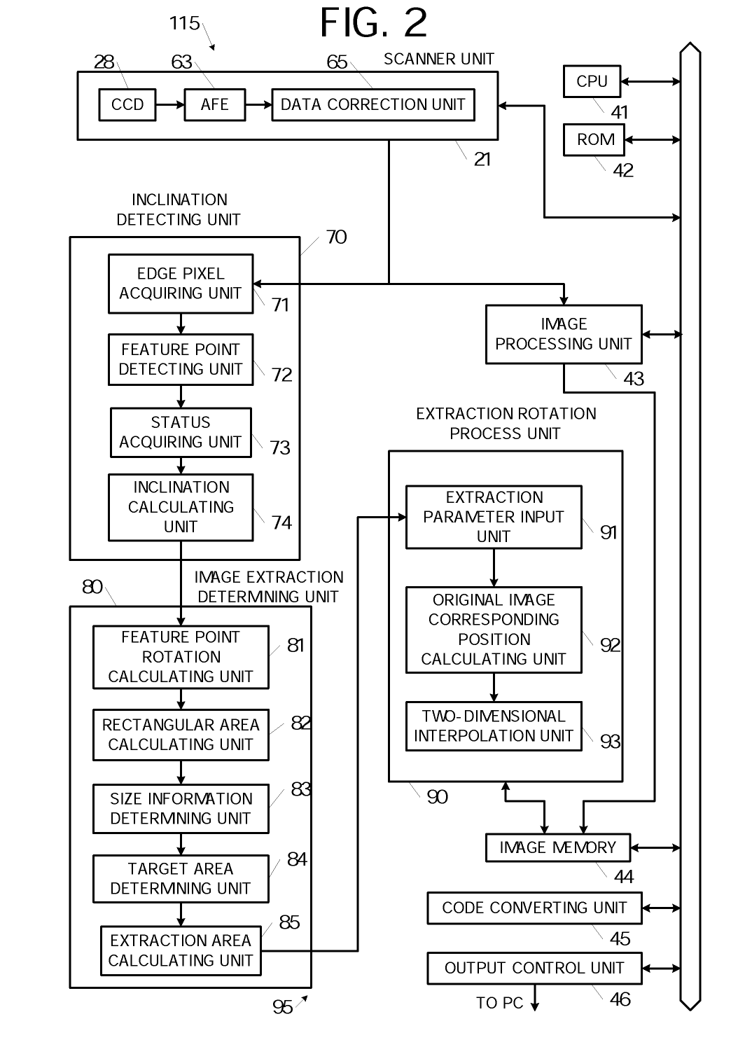

FIG. 2 is a block diagram of the image scanner apparatus 101. As illustrated in FIG. 2, in addition to the scanner unit 21, the image scanner apparatus 101 preferably includes a Central Processing Unit (CPU) 41, a Read Only Memory (ROM) 42, an image processing unit 43, an image memory 44, an automatic image acquiring unit (image processing device) 95, a code converting unit 45, and an output control unit 46.

The CPU 41 preferably functions as a control unit that controls, for example, the scanner unit 21, the automatic image acquiring unit 95, the code converting unit 45, and the output control unit 46, which are included in the image scanner apparatus 101. Programs and data, or the like, for the control are stored in the ROM 42, which defines a storage unit.

The scanner unit 21 preferably includes an Analog Front End (AFE) 63. The AFE 63 is preferably connected with the CCD 28. At the time of scanning the original document, the line sensor of each color of RGB included in the CCD 28 scans one line of the original document content in the main scanning direction, and the signal from each line sensor is converted from an analog signal into a digital signal through the AFE 63. By this main scanning, pixel data of one line is output as a tone value of each color of RGB from the AFE 63. By repeating the above-described process while the original document is being transported or the carriage 30 is moved in the sub scanning direction, image data of an entire scanning area including the original document can be acquired as digital signals.

The scanner unit 21 (the CCD 28) preferably scans not only an area of the original document but also an area that includes the original document that is slightly greater in size than the original document. Thus, original document pixels and background pixels, which will be described below, can be detected.

The scanner unit 21 preferably includes a data correction unit 65, and the digital signals of the image data output from the AFE 63 are input into the data correction unit 65. The data correction unit 65 preferably performs shading correction on the pixel data input line-by-line with respect to each main scanning, and corrects scanned unevenness arising from an optical system of the scanner unit 21. The data correction unit 65 preferably performs, on the pixel data, a correction process that corrects scanning position shift caused by line gaps of the line sensor of each color of RGB of the CCD 28.

The image memory 44 preferably stores images scanned through the scanner unit 21. After well-known image processing (such as filter processing) is performed in the image processing unit 43, the image data scanned through the scanner unit 21 is input into the image memory 44 where it is stored.

The automatic image acquiring unit 95 preferably extracts a rectangular area of a proper size including an original document area from the image data, and thus acquires an original document image having no inclination by rotating the extracted area. The automatic image acquiring unit 95 preferably includes an inclination detecting unit 70, an image extraction determining unit 80, and an extraction rotation process unit 90.

The inclination detecting unit 70 preferably detects an inclination of the original document scanned through the CCD 28. When the image data is input line by line from the data correction unit 65 of the scanner unit 21, the inclination detecting unit 70 analyzes the input image data and detects an inclination (i.e., an angle to be rotated to correct the inclination) of the original document.

The inclination detecting unit 70 preferably includes an edge pixel acquiring unit 71, a feature point detecting unit 72, a status acquiring unit 73, and an inclination calculating unit 74.

Each time the image data is input line by line from the scanner unit 21, the edge pixel acquiring unit 71 preferably acquires, with respect to each line, a position of an edge pixel positioned at an outline portion (in other words, a boundary between the original document and a background) of the original document.

The feature point detecting unit 72 can store the positions of the edge pixels of a prescribed number of lines acquired through the edge pixel acquiring unit 71. Based on features of the positions of the edge pixels of the plurality of lines, feature points related to an outline of the original document are detected, and positions of the feature points can be acquired. In the present preferred embodiment, the “feature point” refers to a point that is positioned at a graphic characteristic portion of the outline of the original document, such as the top of a corner portion of the original document.

The status acquiring unit 73 preferably checks the positions of the edge pixels of the line including the feature points acquired through the feature point detecting unit 72 or of the line that is disposed in the vicinity of the previous line. Based on the checked result, the status acquiring unit 73 preferably acquires a status regarding an inclination of the original document (such as a status indicating that the original document is not inclined, and a status indicating that the original document is inclined towards one side, or is inclined towards the other side, for example).

Preferably, the inclination calculating unit 74 counts the status of each feature point and acquires the most commonly counted status, selects two feature points from the feature points that have a status that matches to the most commonly counted status, calculates and acquires a value (i.e., a parameter that expresses the inclination, or, a tangent value in the present preferred embodiment of the present invention) regarding the inclination of the original document from the positions of the selected feature points.

Preferably, based on a size of an original document portion of the scanned image data and on the inclination of the original document, or the like, the image extraction determining unit 80 automatically determines an area to be extracted from the image data. The image extraction determining unit 80 preferably includes a feature point rotation calculating unit 81, a rectangular area calculating unit 82, a size information determining unit 83, a target area determining unit 84, and an extraction area calculating unit 85.

The feature point rotation calculating unit 81 preferably inputs the value regarding the original document inclination acquired through the inclination calculating unit 74, and then calculates positions of rotated points obtained by rotating and moving the plurality of feature points, which are detected through the feature point detecting unit 72, by the inclination angle (i.e., in a direction for correcting the original document inclination) centering around a prescribed center point.

Based on the positions of the feature points after the rotation (hereinafter, referred to as the rotated feature points) acquired through the feature point rotation calculating unit 81, the rectangular area calculating unit 82 preferably calculates a position and a size of a non-inclined rectangular area having an outline that is disposed in the vicinity of the rotated feature points.

Based on the size of the rectangular area acquired through the rectangular area calculating unit 82, the size information determining unit 83 preferably extracts the original document portion of the image data, and then determines information (size information) about an output size that is suitable for correcting the inclination and outputting the data.

The target area determining unit 84 preferably determines a position of a non-inclined, rectangular original document target area which has a size that corresponds to the size information. The position of the target area is preferably set to include at least a substantial portion of the rectangular area calculated through the rectangular area calculating unit 82.

The extraction area calculating unit 85 calculates an extraction area of the image data by rotating, around the center point, the original document target area determined through the target area determining unit 84.

Based on the process results of the inclination detecting unit 70 and the image extraction determining unit 80, the extraction rotation process unit 90 preferably extracts the image data stored in the image memory 44 in accordance with the extraction area, and electronically corrects the original document inclination by rotating the extracted data. The extraction rotation process unit 90 preferably includes an extraction parameter input unit 91, an original image corresponding position calculating unit 92, and a two-dimensional interpolation unit 93.

The extraction parameter input unit 91 preferably inputs information about the extraction area calculated through the extraction area calculating unit 85. By properly performing a calculation based on the extraction area information, the extraction parameter input unit 91 can acquire two inclination integer parameters as a first integer parameter “a” and a second integer parameter “b”. A ratio value (“a/b”) of the two integer parameters “a” and “b” is equal to a tangent value “tan θ” of the angle (the inclination angle of the original document) by which the image should be rotated.

By performing a prescribed calculation based on a position of a target pixel (m, n) of a rotated image, the original image corresponding position calculating unit 92 preferably acquires a position of a corresponding target pixel (i, j), which corresponds to the target pixel (m, n) in the original image. By performing the prescribed calculation based on the position of the target pixel, the original image corresponding position calculating unit 92 preferably acquires an x-direction weighting factor “kwx” and a y-direction weighting factor “kwy” that are used in an interpolation process performed through the two-dimensional interpolation unit 93.

Based on the corresponding target pixel (i, j) and three pixels each having at least one of the x-coordinate and the y-coordinate that are different from that of the corresponding target pixel, the two-dimensional interpolation unit 93 performs the two-dimensional interpolation process to acquire a pixel value “Q (m, n)” of the target pixel of the rotated image. In the two-dimensional interpolation process, ratios (“kwx/b” and “kwy/b”) acquired by respectively dividing the x-direction weighting factor “kwx” and the y-direction weighting factor “kwy” by the integer “b” are used. A rotation process performed through the extraction rotation process unit 90 will be described later in detail.

The code converting unit 45 encodes the image data stored in the image memory 44 by performing a well-known compression process such as a Joint Photographic Experts Group (JPEG), for example.

The output control unit 46 preferably transmits the encoded image data to a computer such as a personal computer (not illustrated), for example, which defines a higher-level device connected with the image scanner apparatus 101. A transmission method may be selected and include, for example, a method that uses a Local Area Network (LAN) and/or a method that uses a Universal Serial Bus (USB).

In the present preferred embodiment of the present invention, the data correction unit 65, the inclination detecting unit 70, the image extraction determining unit 80, the extraction rotation process unit 90, and the code converting unit 45 or the like are preferably implemented by using hardware such as Application Specific Integrated Circuits (ASIC) and a Field Programmable Gate Array (FPGA), for example.

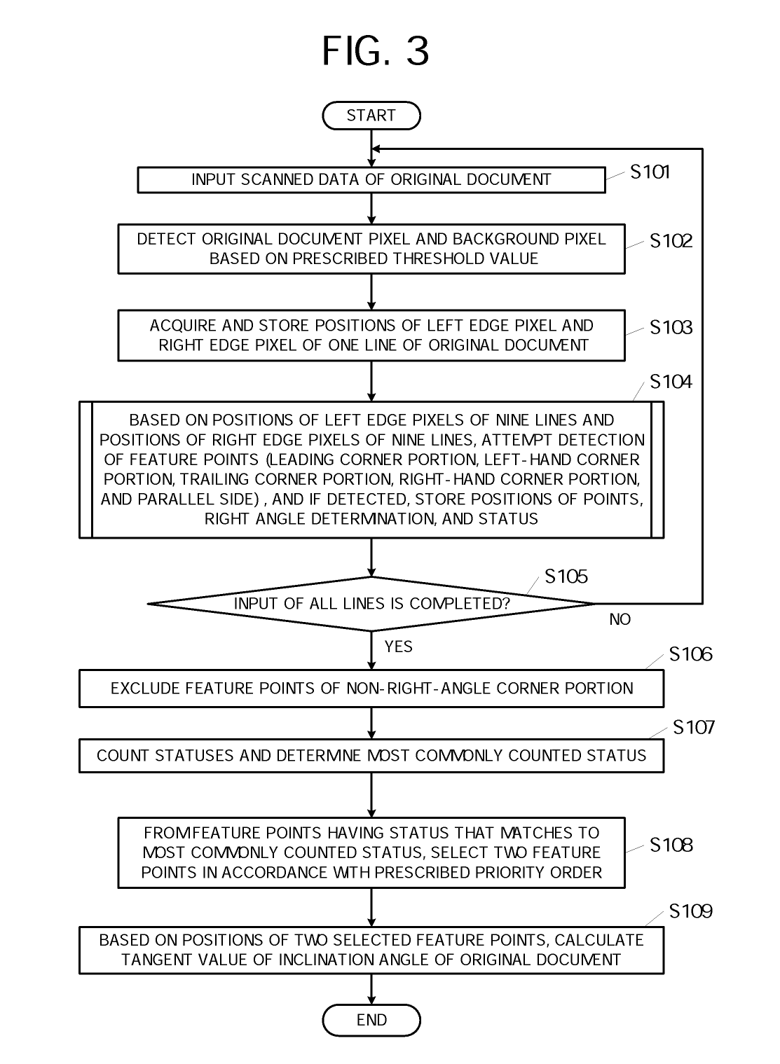

Next, a process of detecting the original document inclination performed by the inclination detecting unit 70 according to a preferred embodiment of the present invention will be described with reference to the flowchart of FIG. 3. FIG. 3 represents a main routine of the inclination detecting process.

When the main routine of FIG. 3 is started, the inclination detecting unit 70 inputs the pixel data of one line output from the data correction unit 65 (S101). Then, a process of detecting an original document pixel and a background pixel from the input pixel data of one line is performed (S102).

In the present preferred embodiment, the process of detecting the original document pixel and the background pixel is preferably performed as follows. A white sheet (i.e., a platen sheet) that is preferably brighter than a normal sheet of paper is attached to a front surface of the pressing pad 121 and to a front surface of the pressing member 122 (FIG. 1) arranged on a reversed side of the original document to be scanned. Accordingly, in the image data scanned by the CCD 28, a background portion surrounding the original document preferably has higher luminance.

Thus, in the process of S102, image processing that calculates luminance (Y component) from RGB components of the pixel data is performed in accordance with a well-known expression. When the calculated luminance is greater than or equal to a prescribed threshold value, a binarization process that determines a pixel as a background pixel is performed, and when the calculated luminance is below the threshold value, a binarization process that determines a pixel as the original document pixel is performed. In the present preferred embodiment, “0” refers to the background pixel, and “1” refers to the original document pixel.

In view of detection accuracy of the original document pixel and the background pixel, proper image processing, such as shading correction and gamma correction, for example, may preferably be performed on the original image data before the process of S102. In the shading correction, the original document can be easily distinguished from the background by a process of adding a prescribed value of white shading data to generate a value that is brighter than a normal value.

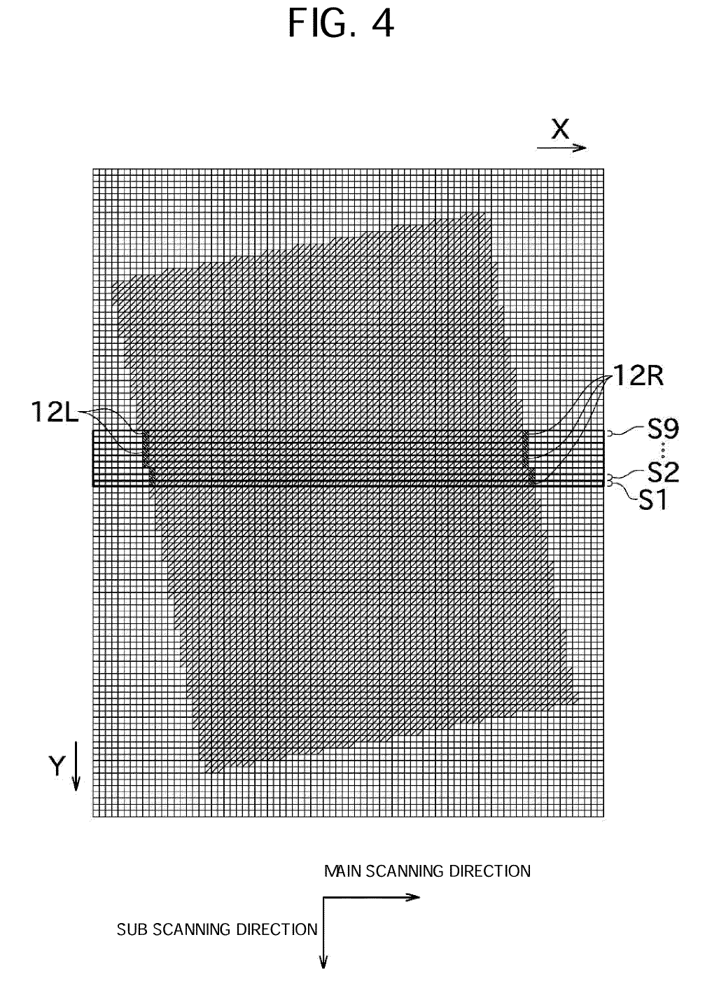

Accordingly, as illustrated in FIG. 4, an original document area can be determined from the image data. In FIG. 4, each box of the finely separated grid indicates one pixel, each blank box indicates a background pixel, and each shaded box indicates an original document pixel. In FIG. 4, a direction “X” indicates the main scanning direction, and a direction “Y” indicates the sub scanning direction.

In FIG. 4, the entire image data is illustrated to easily recognize an entire area of the original document pixels, however, the process of detecting the original document pixels and the background pixels of S102 in FIG. 3 is sequentially performed pixel by pixel along a line in the same direction as the main scanning direction. In the following description, the inclination detecting process will be described in which a rectangular original document is transported in an oblique state through the ADF unit, scanned through the scanner unit 21, and as result, a rectangular image that is slightly rotated in a counterclockwise direction from a proper position is acquired as an original document pixel area as illustrated in FIG. 4. When the rectangular original document is obliquely placed on the platen glass 102 of the flat bed scanner unit, the image inclined as illustrated in FIG. 4 is also acquired as the original document pixel area. Through the inclination detecting unit 70, the image data is processed line by line from an upper edge thereof, as shown in FIG. 4, and a line of a lower edge is processed last.

As described above, in the process of S102 of FIG. 3, the pixels are processed one pixel at a time from one edge to the other edge (from the left edge to the right edge) of each line. Each time the process of S102 is performed on one pixel, a change in the binarized data is checked (S103). In the process of S103, when the pixels are sequentially processed from the left edge with respect to each line, the pixel of “1” at a position at which the binarized pixel changes from “0” to “1” first (in other words, from the background to the original document) is recognized as a first edge pixel (a left edge pixel). The pixel that is “1” at a position at which the binarized pixel changes from “1” to “0” last (in other words, from the original document to the background) is recognized as a second edge pixel (a right edge pixel).

The two edge pixels (the left edge pixel and the right edge pixel) acquired as described above indicate the boundary between the original document and the background (i.e., the outline of the original document) on the corresponding line. In the process of S103, positions of the left edge pixel and the right edge pixel are stored in the memory, which defines a proper storage unit.

The inclination detecting unit 70 of the present preferred embodiment can store the positions of the two acquired edge pixels of the currently processed line, and the positions of each of the two acquired edge pixels of the immediately previously processed eight lines, that is, the positions of each of the two acquired edge pixels of the nine lines in total. In FIG. 4, reference symbol S1 refers to the line that is processed at a particular moment, and S2 through S9 refer to the immediately previously processed eight lines. Moreover, fine hatching is performed on the grids that correspond to the positions of left edge pixels 12L and of right edge pixels 12R.

After the process of detecting the edge pixels, based on features of the positions of the left edge pixels 12L and the right edge pixels 12R of the nine lines, feature points (for example, the top of a corner portion of the original document) regarding the outline of the original document are detected (S104).

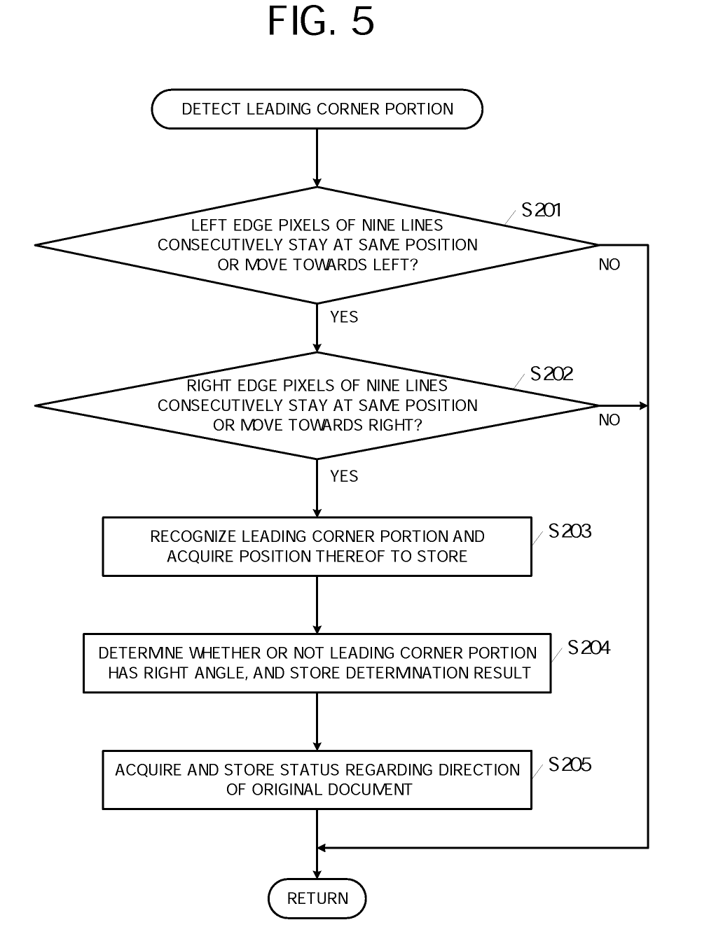

Now, with reference to FIG. 5, a process of detecting a corner portion (i.e., a leading corner portion) positioned on a leading side of the original document will be described as the first example of a specific process of detecting the feature points. The flow of FIG. 5 represents one sub routine executed in the process of S104 of FIG. 3.

In the sub routine of FIG. 5, in the nine lines from the line that was processed earliest (hereinafter, referred to as the “earliest line”) to the line that is currently processed, as the previous line comes closer line by line to the new line, it is checked to determine whether each of the left edge pixels consecutively stays at the same position or moves towards the left (S201). If the above-described conditions are not met, it is determined that the leading corner portion has not been detected, and the sub routine is ended.

If the conditions of S201 are met, as the earliest line comes closer line by line to the currently processed line, it is checked to determine whether each of the right edge pixels consecutively stays at the same position or moves towards the right (S202). If the conditions of S202 are met, the leading corner portion is recognized (S203). If the conditions are not met, it is determined that the leading corner portion has not been detected, and the sub routine is ended.

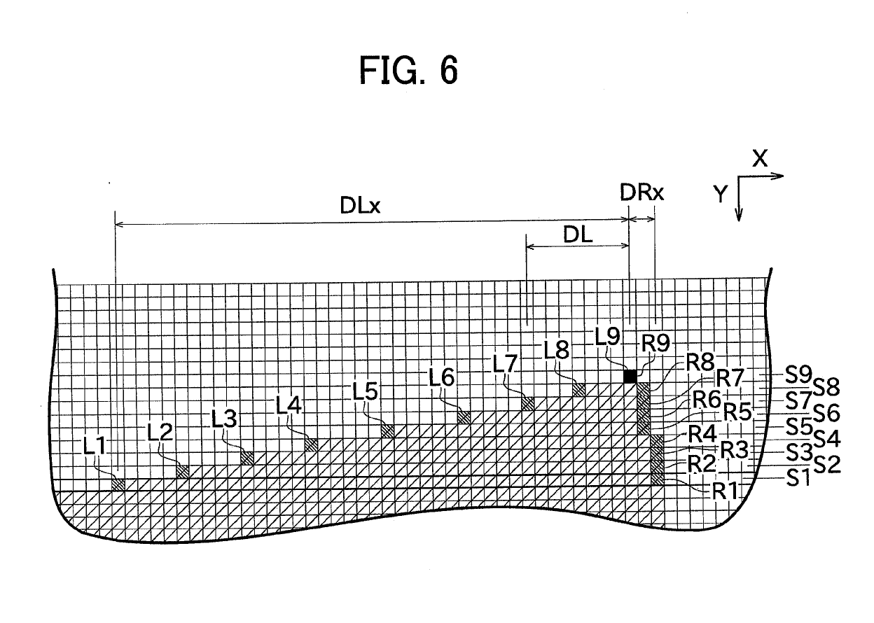

The determinations made in S201 and S202 will be described in detail with reference to FIG. 6. The line S1, which is currently processed, is illustrated in FIG. 6, and it is assumed that, as a result of the process of S103 of FIG. 3, the positions of the left edge pixel L1 and of the right edge pixel R1 have been acquired as illustrated in FIG. 6. It is also assumed that, in the processes performed on the immediately previously processed eight lines, the position of each of the left edge pixels L2 through L9 and the position of each of the right edge pixels R2 through R9 have been acquired and stored.

In this case, in the process of S201 of FIG. 5, in an area of the nine lines, as the previous line comes closer line by line to the new line, it is determined whether each of the left edge pixels stays at the same position or moves towards the left.

For example, in FIG. 6, as the earliest line S9 shifts to a newer line S8, the position of the left edge pixel moves from L9 to L8 in a direction that comes closer to a left edge. It is the same in the case in which the line S8 shifts to the line S7 through the case in which the line S2 shifts to the currently processed line S1 (L8 through L1). Accordingly, in the case of FIG. 6, it is determined that the conditions of S201 of FIG. 5 are met.

In the process of S202, in the area of the nine lines, as the previous line comes closer line by line to the new line, it is determined whether each of the right edge pixels stays at the same position or moves towards the right.

In the example of FIG. 6, as the earliest line S9 shifts to the newer line S8, the position of the right edge pixel moves from R9 to R8 in a direction that comes closer to a right edge. When the line S8 shifts to the line S7, it is obvious from R8 and R7 that the right edge pixel stays at the same position. When the line S7 shifts to the line S6, and when the line S6 shifts to the line S5, each of the right edge pixels stays at the same position (R7 through R5). When the line S5 shifts to the line S4, the right edge pixel moves from R5 to R4 in a direction that comes closer to the right edge. When the line S4 shifts to the line S3, and when the line S3 shifts to the line S2, each of the right edge pixels stays at the same position. When the line S2 shifts to the currently processed line S1, the right edge pixel moves from R2 to R1 in the direction that comes closer to the right edge. Accordingly, in the case of FIG. 6, it is determined that the conditions of S202 of FIG. 5 are met.

Accordingly, in the example of FIG. 6, the sub routine proceeds to the process of S203, and the leading corner portion of the original document is recognized. More specifically, the position of the original document pixel on the earliest line S9 is recognized as the position of the leading corner portion. In FIG. 6, since there is only one original document pixel on the line S9, the pixel is recognized as the leading corner portion (illustrated as the blackened grid). In case there is no original document pixel on the line S9, the left edge pixel L8 or the right edge pixel R8 on the line S8 may be recognized as the feature point. The detected position of the leading corner portion of the original document is stored in the proper memory.

When the leading corner portion of the original document is detected as described above, it is then determined in the process of S204 of FIG. 5 whether or not the corner portion has an approximately right angle.

The determination of the right angle is made based on the features of the positions of the left edge pixels and the right edge pixels of the nine lines. More specifically, a distance DLx by which the left edge pixel moves from the earliest line S9 to the current line S1 towards a left edge side and a distance DRx by which the right edge pixel moves from the earliest line S9 to the current line S1 towards a right edge side are calculated.

When the “DLx>DRx”, it is checked whether or not a distance DL by which the left edge pixel moves towards the left edge side while the earliest line S9 shifts to the newer line by DRx lines (substantially) is equal to 8. When the distance DL is substantially equal to 8, it is determined that the corner portion has an approximately right angle. When the distance DL is not substantially equal to 8, it is determined that the corner portion does not have a right angle.

When the “DLx<DRx”, it is checked whether or not a distance DR by which the right edge pixel moves towards the right edge side while the earliest line S9 shifts to the newer line by DLx lines is substantially equal to 8. When the distance DR is substantially equal to 8, it is determined that the corner portion has an approximately right angle. When the distance DR is not substantially equal to 8, it is determined that the corner portion does not have a right angle.

In the example of FIG. 6, while the earliest line S9 shifts to the current line S1, the left edge pixel moves by 42 pixels towards the left edge side, and the right edge pixel moves by 2 pixels towards the right edge side (refer to the positions of L9, L1, R9, and R1). Accordingly, since the “DLx=42” and the “DRx=2”, the “DLx>DRx”. While the earliest line S9 shifts to the newer line S7, the left edge pixel moves from L9 to L7 by 8 pixels towards the left edge side, and “DL=8”. Accordingly, in the example of FIG. 6, it is determined in the process of S204 of FIG. 5 that the leading corner portion is perpendicular or substantially perpendicular.

In the process of S205, the status regarding the direction of the original document is acquired. The status indicates whether the original document is not inclined, the document is rotated in a clockwise direction, or the document is rotated in a counterclockwise direction. In addition, the status may preferably indicate whether the original document is not required to be rotated, the document is required to be rotated in the counterclockwise direction, or the document is required to be rotated in the clockwise direction.

More specifically, when the distances DLx and DRx satisfy the relationship of “DLx>DRx”, the rotation in the counterclockwise direction is determined, and when the distances DLx and DRx satisfy the relationship of “DLx<DRx”, the rotation in the clockwise direction is determined. When the “DLx=0” and the “DRx=0”, it is determined that the document is not inclined.

In the example of FIG. 6, since the “DLx>DRx”, it is determined in S205 of FIG. 5 that the image is rotated in the counterclockwise direction. Accordingly, in the process of S205, the status of “counterclockwise rotation” is stored in a proper memory in association with the position of the leading corner portion acquired in the process of S203.

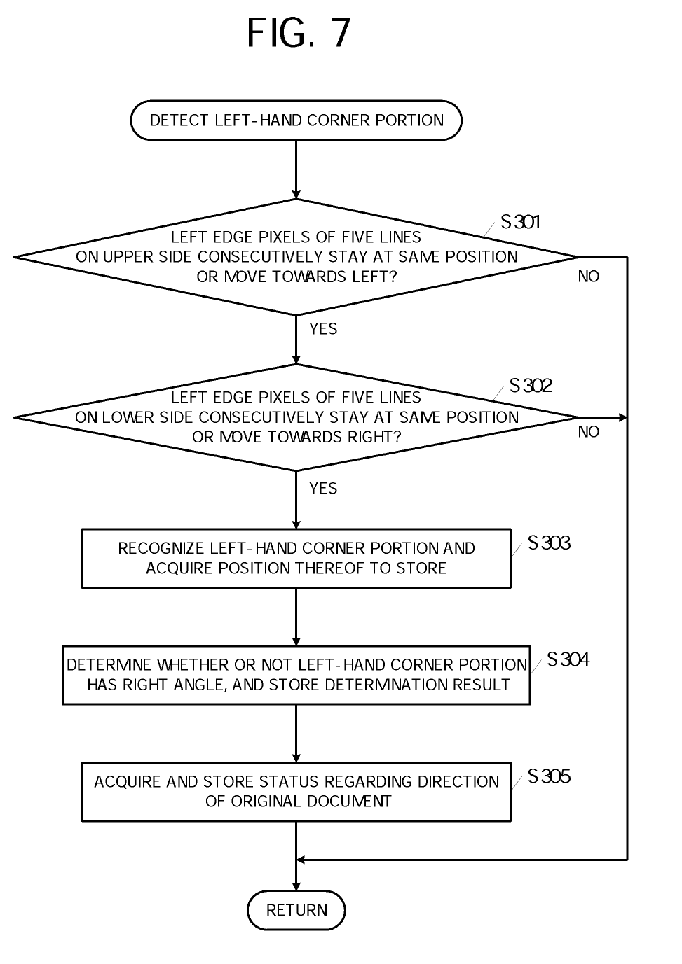

Next, with reference to FIG. 7, a process of detecting a corner portion (left-hand corner portion) that is positioned on the left side of the original document will be described as the second example of a specific process of detecting feature points. Similarly to the flow of FIG. 5, the flow of FIG. 7 represents one sub routine executed in S104 of FIG. 3.

When the sub routine of FIG. 7 is executed, firstly, in the nine lines, positions of the left edge pixels of the five lines from the earliest line S9 to the line S5, which is the center line, are checked (S301). More specifically, in the lines S9 through S5, as the previous line comes closer line by line to the new line, it is checked whether each of the left edge pixels stays at the same position or moves towards the left. When these conditions are not met, it is determined that the left-hand corner portion has not been detected, and the sub routine is ended.

When the conditions of S301 are met, the positions of the right edge pixels of the five lines from the center line S5 to the currently processed line S1 are checked (S302). More specifically, in the lines S5 through S1, as the previous line comes closer line by line to the new line, it is checked whether each of the left edge pixels stays at the same position or moves towards the right. When these conditions are met, the left-hand corner portion is recognized (S303). When the conditions are not met, it is determined that the left-hand corner portion has not been detected, and the sub routine is ended.

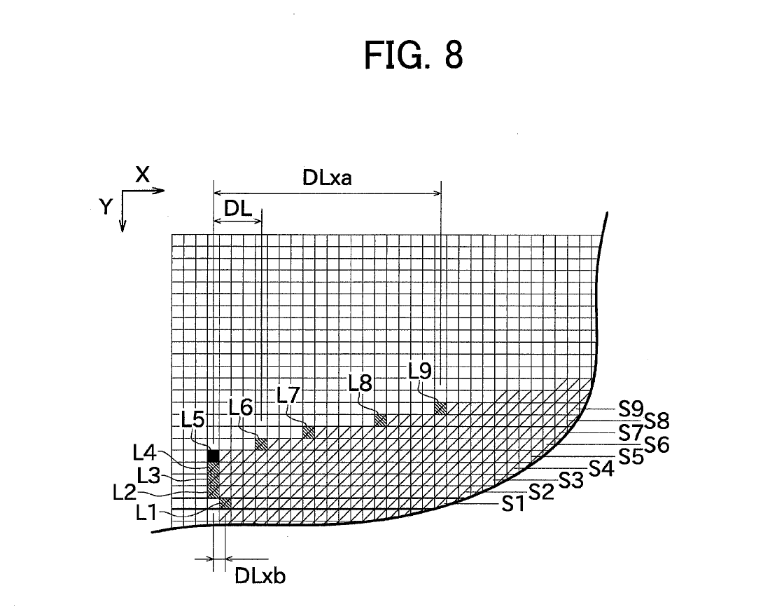

The determinations made in S301 and S302 will be described in detail with reference to FIG. 8. In FIG. 8, the currently processed line S1 is illustrated. It is assumed that the position of the left edge pixel L1 is acquired as illustrated in FIG. 8 in the process of S103 of FIG. 3. It is also assumed that the positions of the left edge pixels L2 through L9 have been acquired and stored in the processes performed on the previously processed eight lines.

In this case, in the process of S301 of FIG. 7 as described above, in the area of the five lines from S9 to S5, as the previous line comes closer line by line to the new line, it is checked whether each of the left edge pixels stays at the same position or moves towards the left.

In FIG. 8, for example, as the earliest line S9 shifts to the newer line S8, the position of the left edge pixel moves from L9 to L8 in a direction that comes closer to the left edge. It is the same in the case in which the line S8 shifts to the line S7 and in the case in which the line S6 shifts to the line S5 (L8 through L5). Accordingly, in the case of FIG. 8, it is determined that the conditions of S301 of FIG. 7 are met.

In the process of S302, in the area of the five lines from S5 to S1, as the previous line comes closer line by line to the new line, it is determined whether each of the left edge pixels stays at the same position or moves towards the right.

In the example of FIG. 8, when the line S5 shifts to the line S4, it is obvious from L5 and L4 that the left edge pixel stays at the same position. When the line S4 shifts to the line S3, and when the line S3 shifts to the line S2, each of the left edge pixels stays at the same position (L4 through L2). When the line S2 shifts to the currently processed line S1, the left edge pixel moves from L2 to L1 in a direction that comes closer to the right edge. Accordingly, in the case of FIG. 8, it is determined that the conditions of S302 of FIG. 7 are met.

Then, in the example of FIG. 8, the sub routine proceeds to the process of S303, and the left-hand corner portion of the original document is recognized. More specifically, as illustrated in FIG. 8, the position of the left edge pixel L5, which is on the line S5 positioned at the approximate center of the nine lines, is recognized as the position of the left-hand corner portion (refer to the blackened grid). The position of the left edge pixel L2 on the line S2, for example, may be recognized as the position of the left-hand corner portion. The detected position of the left-hand corner portion of the original document is stored in the proper memory.

When the left-hand corner portion of the original document is detected, it is determined in the process of S304 of FIG. 7 whether or not the corner portion has an approximately right angle.

The determination of the right angle is performed as follows. That is, a distance DLxa by which the left edge pixel moves from the earliest line S9 to the center line S5 towards the left edge side is acquired. A distance DLxb by which the left edge pixel moves from the center line S5 to the currently processed line S1 towards the right edge side is also acquired.

Then, when the “DLxa>DLxb”, it is checked whether or not a distance DL by which the left edge pixel moves towards the right edge side while the center line S5 shifts to the older line by DLxb lines is substantially equal to 4. When the distance DL is substantially equal to 4, it is determined that the corner portion has an approximately right angle. When the distance DL is not substantially equal to 4, it is determined that the corner portion does not have a right angle.

When the “DLxa<DLxb”, it is checked whether or not a distance DL by which the left edge pixel moves towards the right edge side while the center line S5 shifts to the newer line by DLxa lines is substantially equal to 4. When the distance DL is substantially equal to 4, it is determined that the corner portion has an approximately right angle, and when the distance DL is not substantially equal to 4, it is determined that the corner portion does not have a right angle.

In the example of FIG. 8, while the earliest line S9 shifts to the center line S5, the left edge pixel moves by 19 pixels towards the left edge side (see the positions of L9 and L5). While the center line S5 shifts to the currently processed line S1, the left edge pixel moves only by 1 pixel towards the right edge side (see the positions of L5 and L1). Accordingly, since the “DLxa=19”, and the “DLxb=1”, the “DLxa>DLxb”. While the center line S5 shifts to the line S6, since the left edge pixel moves from L5 to L6 by 4 pixels towards the right edge side, the “DL=4”. Accordingly, in the example of FIG. 8, it is determined in the process of S304 of FIG. 7 that the left-hand corner portion is substantially perpendicular.

In the process of S305, the status regarding the direction of the original document is acquired. More specifically, when the distances DLxa and DLxb satisfy the relationship of “DLxa>DRxb”, the rotation in the counterclockwise direction is determined, and when the distances DLxa and DLxb satisfy the relationship of “DLxa<DRxb”, the rotation in the clockwise direction is determined.

In the example of FIG. 8, since the “DLxa>DLxb”, it is determined that the image is rotated in the counterclockwise direction. Accordingly, in the process of S305, the status of “counterclockwise rotation” is stored in the proper memory in association with the position of the left-hand corner portion acquired in the process of S303.

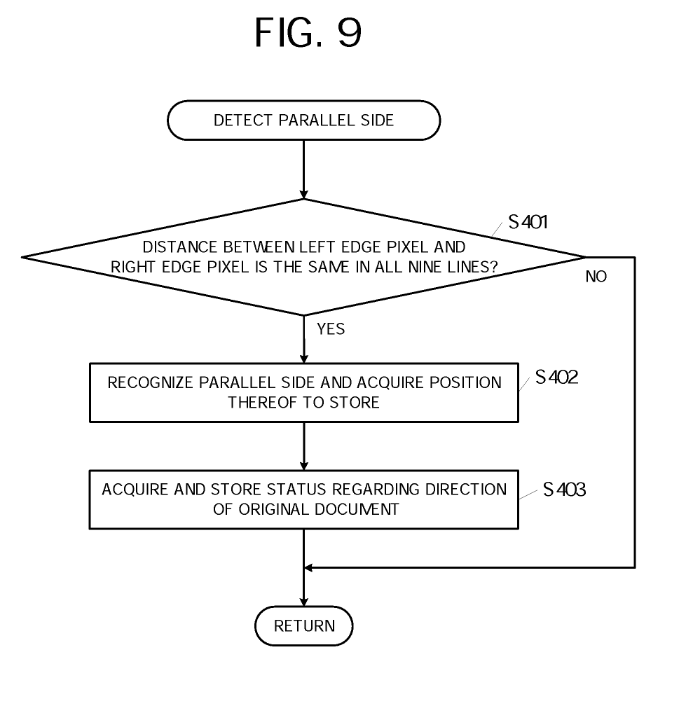

Next, with reference to FIG. 9, a process of detecting points on parallel or substantially parallel sides of the original document will be described as the third example of a specific process of detecting feature points. Similarly to the flowcharts of FIGS. 5 and 7, the flowchart of FIG. 9 represents one sub routine executed in the process of S104 of FIG. 3.

In the sub routine of FIG. 9, first, it is checked whether or not a distance between the left edge pixel and the right edge pixel in each of the nine lines is substantially the same (S401). When the conditions of S401 are met, the parallel or substantially parallel sides are recognized (S402). When the conditions are not met, it is determined that the parallel or substantially parallel sides have not been detected, and the sub routine is ended.

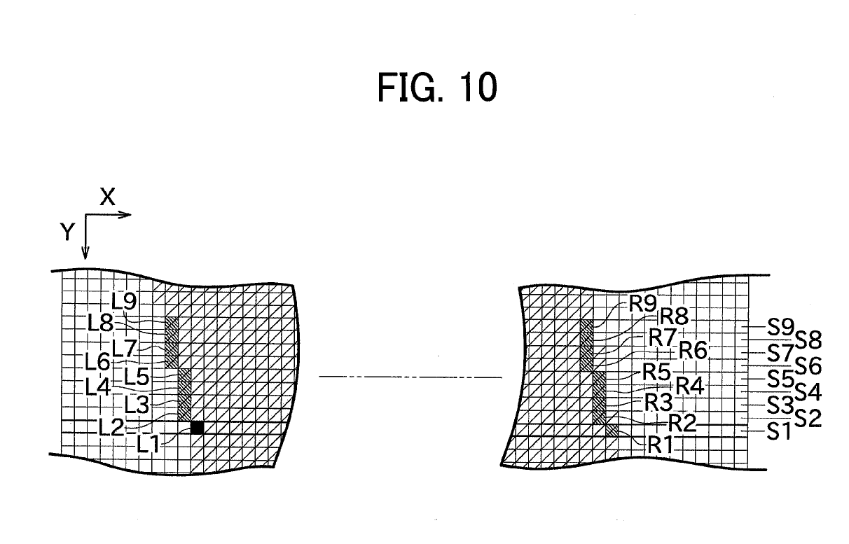

The determination made in S401 will be described in detail with reference to FIG. 10. In FIG. 10, the currently processed line S1 is illustrated. It is assumed that, as a result of the process of S103 of FIG. 3, the positions of the left edge pixel L1 and of the right edge pixel R1 are acquired as illustrated in FIG. 10. It is also assumed that the positions of the left edge pixels L2 through L9 and of the right edge pixels R2 through R9 have been acquired and stored in the processes performed on the immediately previously processed eight lines.

In this case, as described above, it is checked in the process of S401 whether or not the distance between the left edge pixel and the right edge pixel in each of the nine lines S1 through S9 is the same.

For example, in FIG. 10, it is obvious from the drawing that the distance between the left edge pixel and the right edge pixel in each of the nine lines S1 through S9 is substantially the same. Accordingly, in the case of FIG. 10, it is determined that the conditions of S401 of FIG. 9 are met.

Accordingly, in the case of FIG. 10, the sub routine proceeds to the process of S402, and the parallel or substantially parallel sides of the original document are recognized. In the process of S402, an arbitrary point on one of the substantially parallel sides is selected and a position thereof is stored in the proper memory. In the present preferred embodiment, the position of the left edge pixel L1 on the currently processed line S1 is stored as a feature point (refer to the blackened grid). The position of the right edge pixel or the position of any edge pixel that is on the previously processed lines S2 through S9 may be stored as the feature point. It is preferable to set both positions of the left edge pixel and the right edge pixel as the feature points because a feature point counted based on the parallel or substantially parallel sides is increased, the accuracy can be enhanced.

Next, in the process of S403 of FIG. 9, the status regarding the direction of the original document is acquired. More specifically, the position “L9” of the left edge pixel of the earliest line S9 is compared with the position “L1” of the left edge pixel of the currently processed line S1. When the position “L1” is closer to the left edge side than the position “L9”, the rotation in the clockwise direction is determined, and when the position “L9” is closer to the left edge side than the position “L1”, the rotation in the counterclockwise direction is determined. When the positions “L1” and “L9” are the same, it is determined that the document is not inclined.

In the example of FIG. 10, the position “L9” is closer to the left edge side than the position “L1”. Accordingly, in the process of S403, the status of “counterclockwise rotation” is stored in the proper memory in association with the position of the point on the substantially parallel side acquired in the process of S402. Then, the sub routine is ended.

When a substantially rectangular original document is scanned, for example, a plurality of feature points are consecutively detected on a parallel or substantially parallel side. In order to prevent such a situation, once the parallel or substantially parallel side is detected, it is preferable that a prescribed number of lines will not be detected. The prescribed number of lines is determined in accordance with the resolution and accuracy of a detection angle, or other suitable parameter. For example, when the scan resolution is 200 dpi, and the number of lines by which the detection of the substantially parallel side is skipped is set to be about 200, the feature points on the parallel or substantially parallel side are detected at an interval of at least about 25.4 mm, for example.

By executing the above-described three sub routines, the leading corner portion, the left-hand corner portion, and the parallel or substantially parallel sides of the original document can be detected. In addition to the above, in the process of S104 of the main routine, sub routines are preferably executed to detect a corner portion (a trailing corner portion) positioned on a trailing side of the original document and a corner portion (a right-hand corner portion) positioned on the right side. Description of the sub routine executed to detect the right-hand corner portion will be omitted since the sub routine can be performed by reversing a positional relationship in the main scanning direction in the above-described sub routine executed to detect the left-hand corner portion.

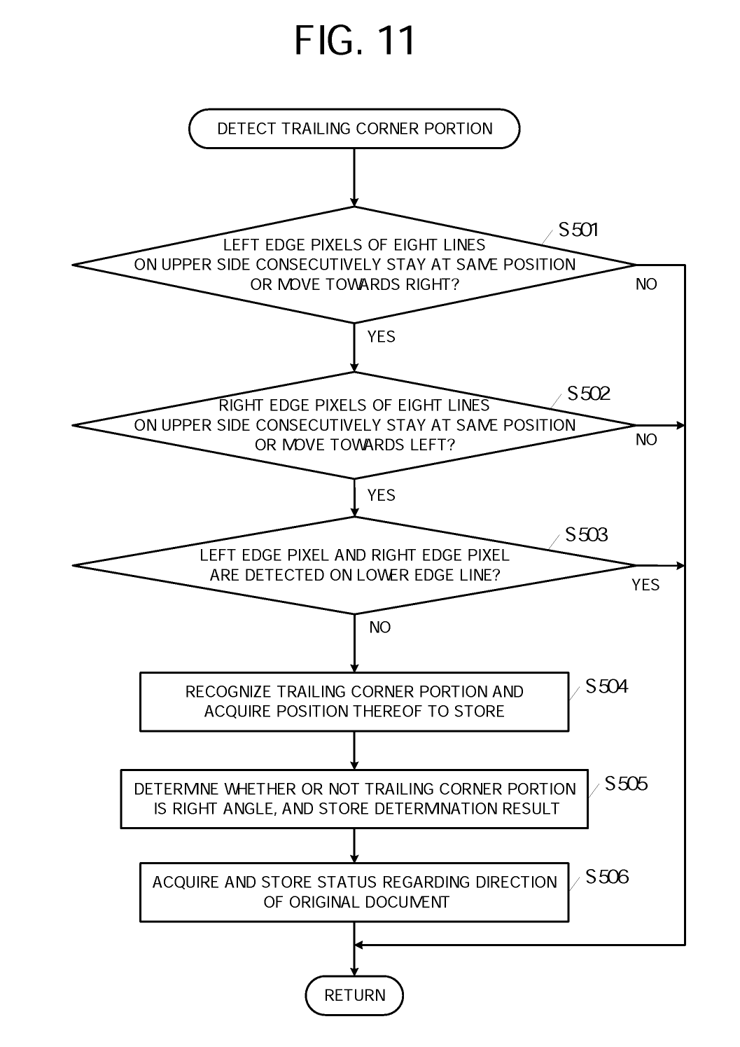

The sub routine to detect the trailing corner portion will be described with reference to FIG. 11. In the sub routine of FIG. 11, first, in the eight lines from the earliest line to the line that is immediately before the current line, as the previous line comes closer line by line to the new line, it is checked whether each of the left edge pixels consecutively stays at the same position or moves towards the right (S501). When these conditions are not met, it is determined that the trailing corner portion has not been detected, and the sub routine is ended.

When the conditions of S501 are met, as the earliest line comes closer line by line to the line immediately before the current line, it is checked whether each of the right edge pixels consecutively stays at the same position or moves towards the left (S502). When these conditions are not met, it is determined that the trailing corner portion has not been detected, and the sub routine is ended.

When the conditions of S502 are met, in the currently processed line, it is checked whether or not the left edge pixel and the right edge pixel are detected (S503). When the pixels are not detected, the trailing corner portion is recognized, and the position thereof is acquired and stored (S504). When the pixels are detected, it is determined that the trailing corner portion has not been detected, and the sub routine is ended.

As the line comes closer to the trailing corner portion of the original document, the left edge pixel moves towards the right side, and the right edge pixel moves towards the left side. When the line passes through the trailing corner portion, the original document pixel is not detected. The processes of S501 through S504 automatically determine the trailing corner portion by using this feature of the trailing corner portion.

Next, it is determined whether or not the detected trailing corner portion has an approximately right angle, and a determination result is stored (S505). The status regarding the direction of the original document is acquired and stored (S506). Since the processes of S505 and S506 are essentially similar to the right angle determining process (S204) and the direction determining process (S205) of the leading corner portion detecting process (FIG. 5), description thereof will be omitted.

When each of the above-described sub routines is ended, and the process of S104 of FIG. 3 is completed, it is determined whether or not the pixel data of all lines has been input (S105). When the input of all lines has not been completed, the process returns to the process of S101.

Each time one line is input, the processes of S103 and S104 are repeated until the original document scanned data of all lines is input by the above-described flow. Accordingly, by looping the processes of S101 through S104, the feature points indicating the leading corner portion, the left-hand corner portion, the trailing corner portion, the right-hand corner portion, and the parallel or substantially parallel side of the original document are detected. Each time the feature point is detected, the position thereof, the determination result indicating whether or not the corner portion has an approximately right angle, and the status regarding the direction of the original document are stored.

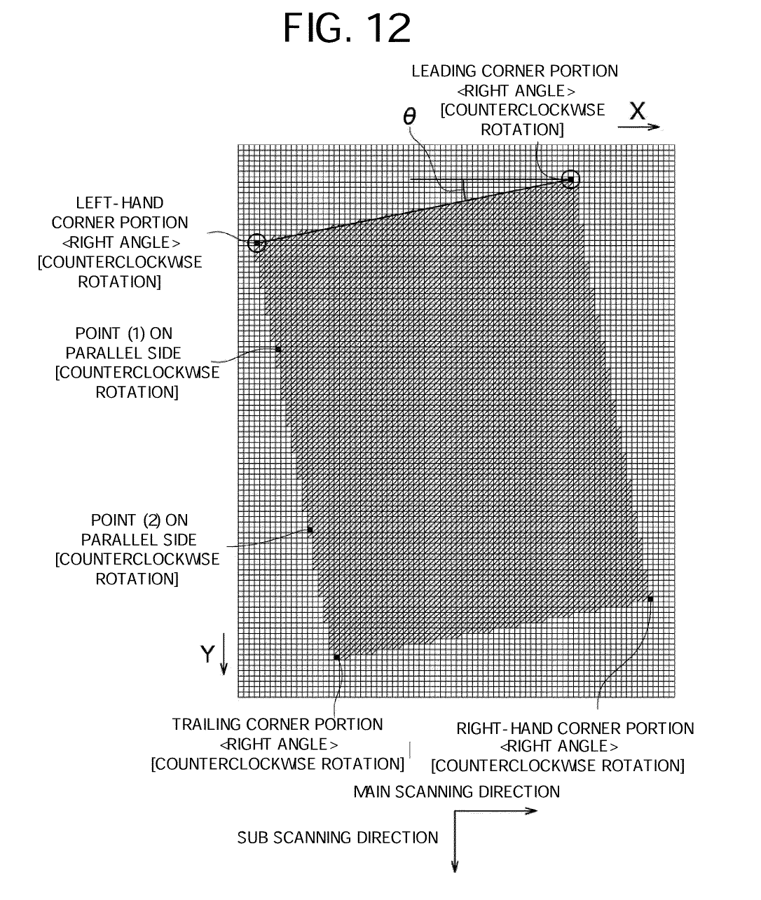

FIG. 12 illustrates an example of the positions of the detected feature points, and the determination of right angle and the status acquired with respect to each feature point. The four corner portions are recognized as the feature points in the present preferred embodiment. Since the corner portion is a point at which two adjacent sides meet, the detection of one corner portion means detection of a point on two sides. Accordingly, when the original document has four sides as illustrated in FIG. 12, at least one feature point is detected on each of the four lines. With respect to the substantially parallel side, two mutually and sufficiently separated points (point (1) and (2) on the parallel or substantially parallel side) are recognized, and each of the positions and statuses thereof is stored.

When the process for the data of all lines is completed, the main routine preferably proceeds to the process of S106 of FIG. 3. In the process of S106, the feature point of the corner portion that has been determined as non right-angle is excluded from the feature points detected in S104. The excluded feature point is not used in the processes of S107 and S108 to be described below. In the example of FIG. 12, since it is determined that each of the four corner portions has an approximately right angle, no feature point is excluded.

Next, the statuses of the acquired feature points are counted, and the most commonly counted status is determined (S107). In the example of FIG. 12, since the statuses of all feature points indicate the “counterclockwise rotation”, the most commonly counted status is determined as the “counterclockwise rotation”. A plurality of most commonly counted statuses may be determined. In such a case, the status is determined in accordance with a predetermined priority order.

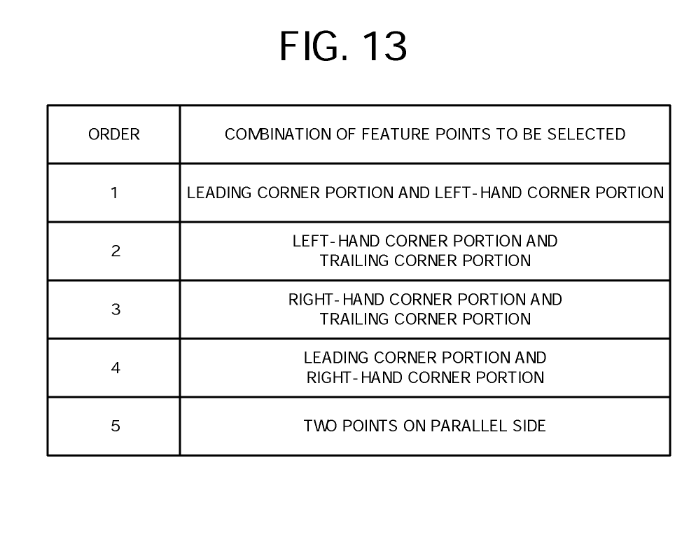

Next, in the process of S108 of FIG. 3, in accordance with the predetermined priority order, a combination of two feature points is selected from the feature points having the status that matches to the most commonly counted status. An example of the priority order is represented in FIG. 13. In this example, the priority order is set such that the two points of the separate corner portions of the original document are preferably higher on the priority order than the two points on the parallel side. Thus, the detection accuracy of the inclination can be improved.

In the example of FIG. 12, since the statuses of all feature points indicate the “counterclockwise rotation”, any feature point can be selected. However, in accordance with the priority order of FIG. 13, the leading corner portion and the left-hand corner portion are preferably selected.

Next, the process proceeds to the process of S109 of FIG. 3, a value regarding the original document inclination is calculated based on the positions of the two selected feature points. In the present preferred embodiment, based on the positions of the points of the selected leading corner portion and the left-hand corner portion, a tangent value of an inclination angle of the original document is preferably acquired. However, a value of the inclination angle of the original document may be acquired based on the inclination of a straight line linking the two feature points, or a sine value or a cosine value may be acquired, for example. That is, any parameter that represents a degree of the inclination may be used.

In the counting process of S107, the statuses of the feature points may be dispersed, and the most commonly counted status may not be acquired. In such a case, regardless of the status, the original document inclination is acquired based on the two points of the parallel or substantially parallel side if the two points on the parallel or substantially parallel side have been acquired.

By the above-described process, similar to the scanned data of the CCD 28, based on the data consecutively output pixel by pixel with respect to each line, the parameter regarding the original document inclination can be calculated and acquired. Then, by sending the parameter (i.e., the tangent value) to the image extraction determining unit 80, the extraction area of the image data can be properly determined. Moreover, since the parameter regarding the original document inclination can be accurately calculated, an image rotating process can be performed with an appropriate angle through the extraction rotation process unit 90, and a preferable scanned image having an electronically corrected inclination can be acquired.

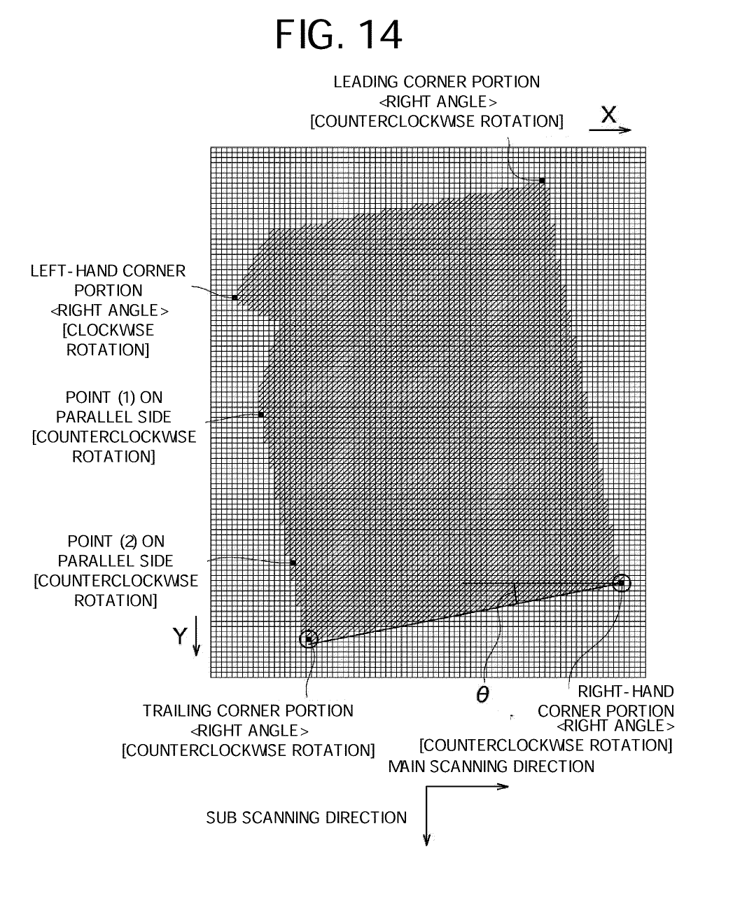

In the above-described inclination detecting process, even if the original document is dog-eared, torn, or otherwise damaged, the inclination can be preferably detected. An example of a scanned result is illustrated in FIG. 14 in which the left-hand corner portion of the original document is dog-eared and torn. In the example of FIG. 14, it is assumed that, when the left-hand corner portion is detected as the feature point, based on features of a shape of the dog-eared portion, it is determined that the left-hand corner portion has an approximately right angle and that the status is the “clockwise rotation”. Similarly to FIG. 12, it is assumed that the feature points of the portions other than the left-hand corner portion are determined to have an approximately right angle if each of the portions is a corner portion, and that the status of “counterclockwise rotation” has been acquired.

In FIG. 14, one feature point indicates the status of “clockwise rotation”, and other five feature points indicate the status of “counterclockwise rotation”. Accordingly, in the process of S107 of FIG. 3, the most commonly counted status is determined to be the “counterclockwise rotation”. As a result, when the feature points are selected in S108, since a left-hand corner portion of FIG. 14 has the status of “clockwise rotation”, which does not match to the most commonly counted status, the left-hand corner portion is not selected. Therefore, in accordance with the priority order of FIG. 13, a right-hand corner portion and a trailing corner portion are selected, and based on the two feature points, the original document inclination is accurately detected.

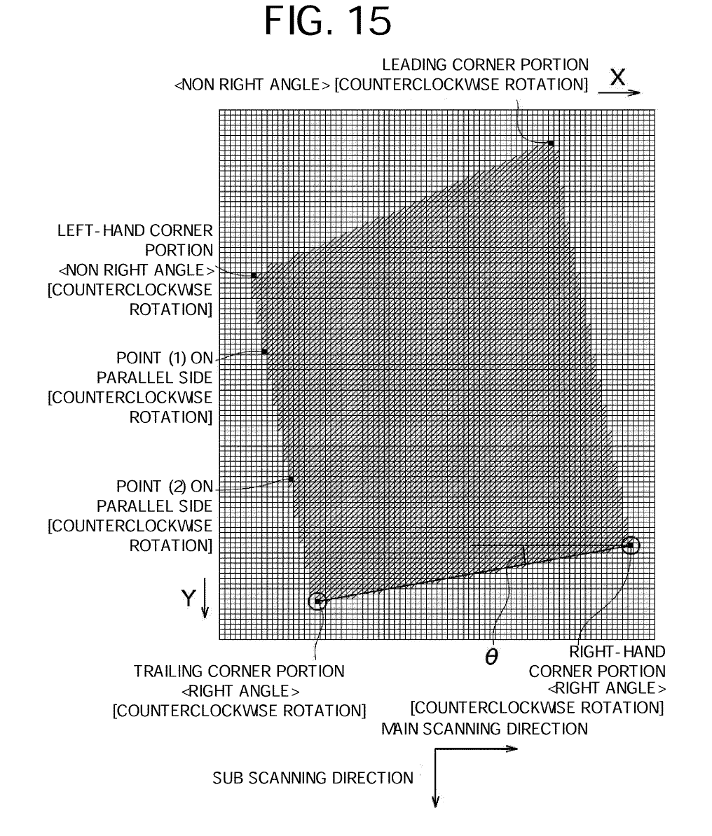

FIG. 15 illustrates an example of a scanned result in which the original document is substantially dog-eared at its leading side and thus has a non-rectangular shape. In the example of FIG. 15, when a leading corner portion and a left-corner portion are detected as the feature points, it is determined that the portions do not have an approximately right angle, and it is determined that a trailing corner portion and a right-corner portion has an approximately right angle.

In this case, in the process of S106 of FIG. 3, the leading corner portion and the left-hand corner portion, which do not have approximately right angles, are excluded. Accordingly, in the most commonly counted status determining process of S107 and the feature point selecting process of S108, the leading corner portion and the left-hand corner portion are excluded. In the example of FIG. 15, the right-hand corner portion and the trailing corner portion are selected, and based on the two feature points, the original document inclination is accurately detected.

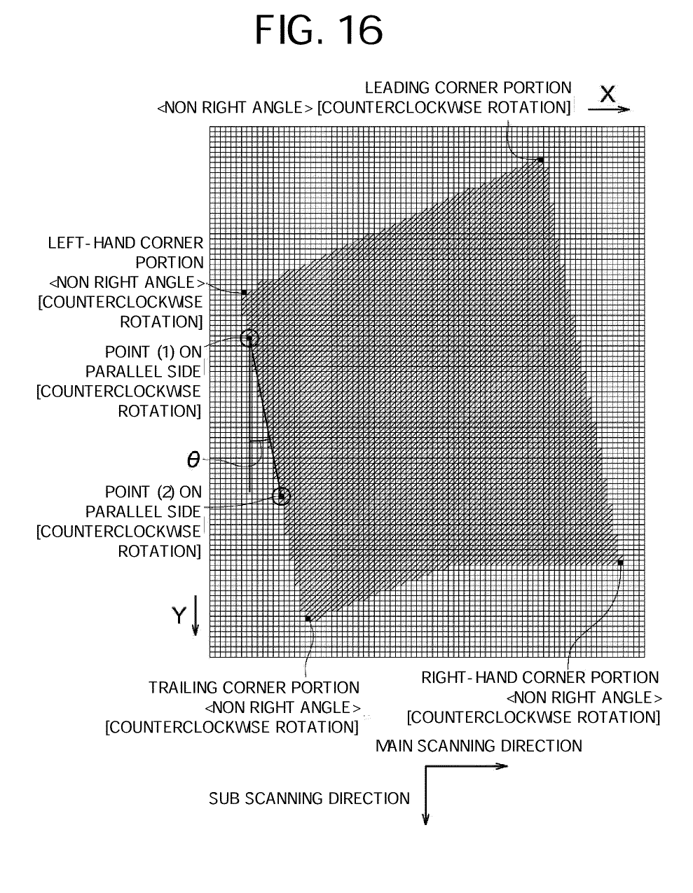

FIG. 16 illustrates an example of a case in which a non-square original document is scanned. It is determined that all of the four detected corner portions do not have an approximately right angle. In such a case, since all of the four corner portions are excluded in the process of S106 of FIG. 3, two points on a parallel or substantially parallel side are selected in the process of S108. Accordingly, even if the original document has a non-square shape, as long as the document has a parallel or substantially parallel side, the inclination can be accurately detected based on the two points on the parallel or substantially parallel side.

The inclination detecting process of the above-described present preferred embodiment can properly detect the inclination regardless of the content of the original document by analyzing the original document pixels. Moreover, the inclination of original documents of various shapes or in various states can be accurately detected even when the original document is dog-eared, torn, for example, or has a round-cornered rectangular shape, a non-rectangular shape, or other unconventional shape.

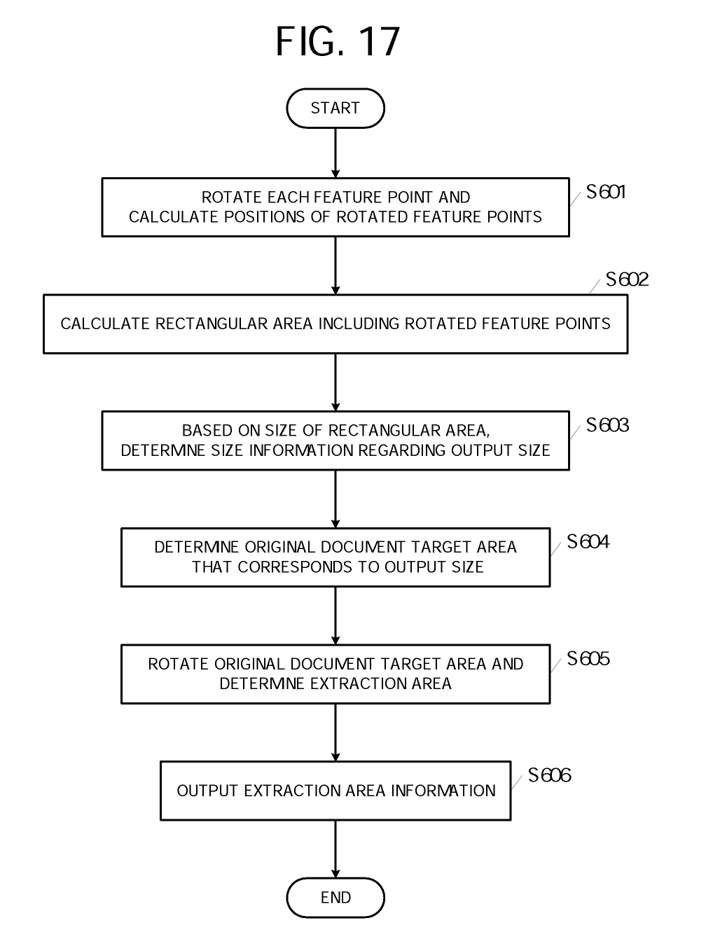

Next, a process of determining an extraction area of a prescribed size including the original document area from the original image data (i.e., a process executed through the image extraction determining unit 80) will be described. FIG. 17 is a flowchart representing the extraction area determining process executed through the image extraction determining unit 80.

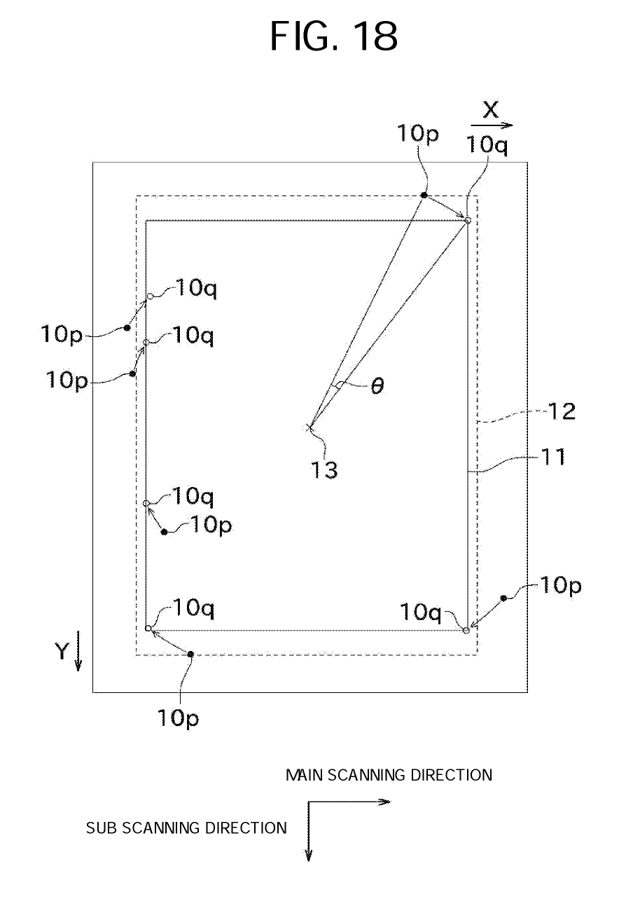

When the flow of FIG. 17 is started, a process of rotating, around a point predetermined as the center, the coordinates of each feature point acquired in the above-described process, by the inclination angle (i.e., in a direction for correcting the inclination) acquired in the above-described inclination detecting process is performed (S601). Such a rotational transfer can preferably be carried out by performing a well-known affine transformation on the x-coordinate and the y-coordinate of each feature point, for example. FIG. 18 represents a process of rotating a plurality of feature points 10p acquired from the data of FIG. 16 around a center point 13 by the inclination angle θ, and then acquiring rotated feature points 10q.

Next, a rectangular area 11 that includes all the rotated feature points 10q is determined (S602). The rectangular area 11 has a non-inclined, rectangular outline including an outline that is adjacent to the rotated feature points.

The rectangular area 11 can be acquired as follows, for example. First, the x-coordinate and the y-coordinate of each of the rotated feature points 10q are acquired, and then a maximum value “xmax” of the x-coordinates, a minimum value “xmin” of the x-coordinates, a maximum value “ymax” of the y-coordinates, and a minimum value “ymin” of the y-coordinates are acquired. A rectangular area having a line connecting the point (xmin, ymin) with the point (xmax, ymax) as a diagonal line is set as the rectangular area 11.

Based on a size of the rectangular area 11, size information regarding an output size is determined (S603 of FIG. 17). The output size corresponds to a medium size that is used when outputting the area extracted from the image data scanned through the scanner unit 21. When a prescribed area is extracted from the image data, when an image having a corrected original document inclination is acquired, and when a Portable Document Format (PDF) file including a page having the image is generated, the size information can be used for describing, in the PDF file, information used to specify a print destination medium size at the time of printing the page. Moreover, when implementing a copy function through a combination of the image scanner apparatus 101 and a suitable image forming apparatus, the size information can be also used for selecting a size of the copying paper in the image forming apparatus.

In the present preferred embodiment, the determination of the output size is performed by selecting a size having a width and a height that are closest to the width and the height of the rectangular area 11 from pre-stored format sizes (such as B5 size, A4 size, B4 size, A3 size, for example, as specified by Japanese Industrial Standards Committee). In addition, depending on user's instructions, the format sizes may not be used as the output size, and the size of the rectangular area 11 may be determined as the output size.

When the output size is determined, a process of determining a position of an original document target area 12 having a width and height that correspond to the output size is performed (S604). Similarly to the rectangular area 11, the original document target area 12 includes a non-inclined rectangular outline. The position of the original document target area 12 is determined such that the original document target area 12 includes at least a substantial portion of the rectangular area 11. In the present preferred embodiment, the position of the original document target area 12 is determined such that the center of the original document target area 12 matches to the center of the rectangular area 11.

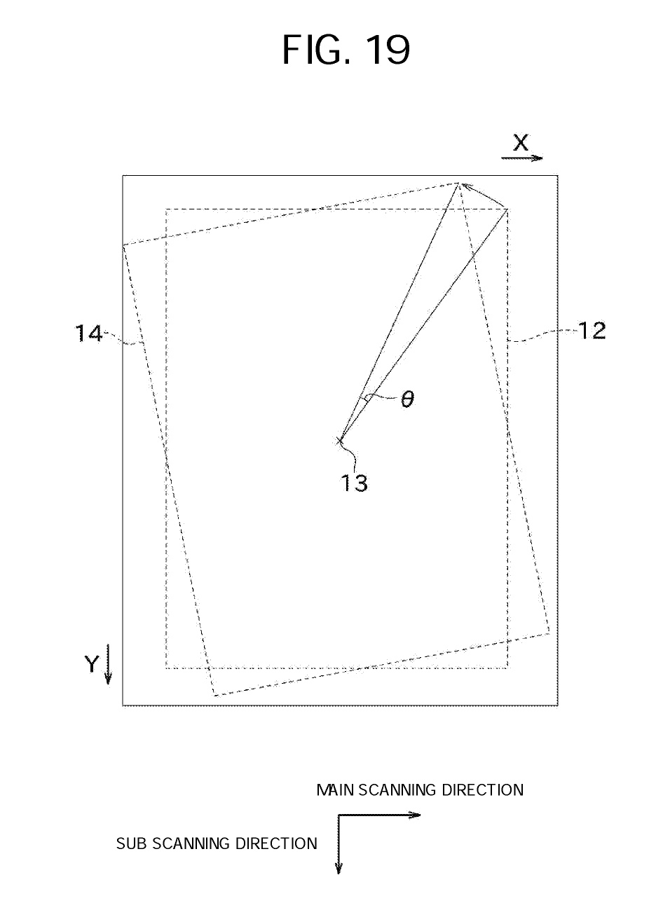

Next, a process of rotating the original document target area 12 around the center point 13 by the inclination angle θ is performed as illustrated in FIG. 19 (S605 of FIG. 17). The rotation direction of the original document target area 12 indicates the direction in which the original document is inclined, and corresponds to the opposite direction of the rotation direction of the feature points illustrated in FIG. 18. Similarly to the process of S602, the rotational transfer is also carried out by using a well-known affine transformation.

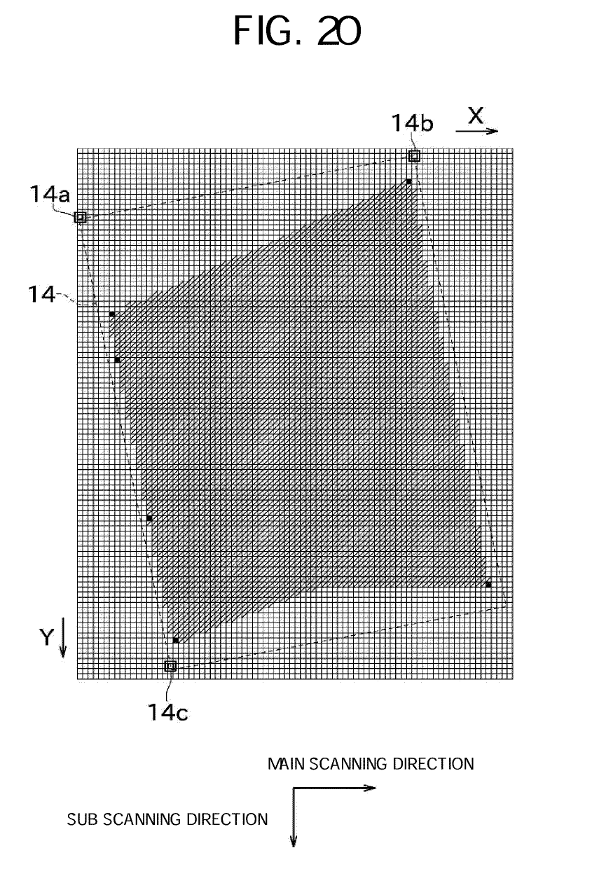

Thus, a rectangular area (extraction area 14) inclined by the same angle as the inclination angle of the original document can be acquired as illustrated in FIG. 19. FIG. 20 illustrates a state in which the extraction area 14 overlaps with the image data of FIG. 16. By extracting an image along the extraction area 14, the rectangular image that includes the original document area in substance and has a size that corresponds to the output size can be acquired.

Information regarding the extraction area 14 is properly output (S606 of FIG. 17) and used for the image extracting process performed through the extraction rotation process unit 90. More specifically, the coordinates of three vertexes 14a, 14b, and 14c among the four vertexes of the rectangular extraction area 14 are transferred as parameters to the extraction rotation process unit 90.

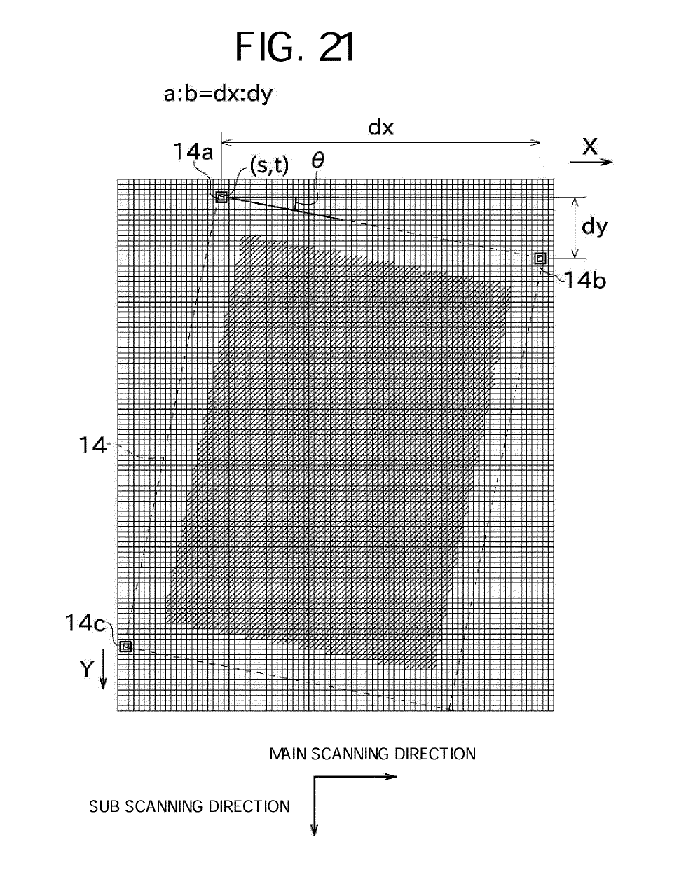

The image extracting process and the image rotating process performed through the extraction rotation process unit 90 will be described. In the example of FIG. 21, a rectangular image slightly rotated in the clockwise direction from the correct direction is acquired as an original document pixel area when the original document is transported through the ADF unit in an oblique state and scanned through the scanner unit 21.

In such a case, similar processes to the above are performed through the image extraction determining unit 80, and as illustrated in FIG. 21, the extraction area 14 having substantially the same inclination as the original document inclination is determined. Then, the coordinates of the three vertexes 14a, 14b, and 14c positioned at corner portions of the extraction area 14 are input to the extraction rotation process unit 90 as extraction parameters.

The extraction rotation process unit 90 preferably stores the input parameters in the proper memory. Then, among the three input vertexes, the extraction rotation process unit 90 preferably calculates and acquires the difference between the x-coordinates and the difference between the y-coordinates of the vertexes 14a and 14b. The acquired difference between the y-coordinates will be referred to as “dy”, and the difference between the x-coordinates will be referred to as “dx”. In the example of FIG. 21, “dy=12”, and “dx=60”, for example.

Then, the extraction rotation process unit 90 divides the difference “dy” of the y-coordinates and the difference “dx” of the x-coordinates respectively by the greatest common factor, and sets the acquired results as inclination parameters “a” and “b”. In the example of FIG. 21, “a=1”, and “b=5”.

Assuming that “θ” refers to an inclination angle of the original document, a relationship of the following formula is established: “θ=tan⁻¹ (dy/dx)=tan⁻¹ (a/b)”. In other words, a ratio value of “a” and “b” (i.e., “a/b”) is equal to a tangent value “tan θ” of the inclination angle of the original document.

Since the x-coordinates and y-coordinates of the two vertexes “14a” and “14b” are represented as an integer, the above-described difference “dy” of the y-coordinates and the difference “dx” of the x-coordinates are expressed as an integer, and the inclination parameters “a” and “b” are also expressed as an integer.

The processes performed through the inclination detecting unit 70 and the image extraction determining unit 80 may be performed without performing resolution conversion (variable power) on an original image, or the angle detection may be performed by using reduced image data acquired by reducing the original image. When processing by software, in particular, the period of time required for the angle detecting process can be shortened by using the reduced image data.

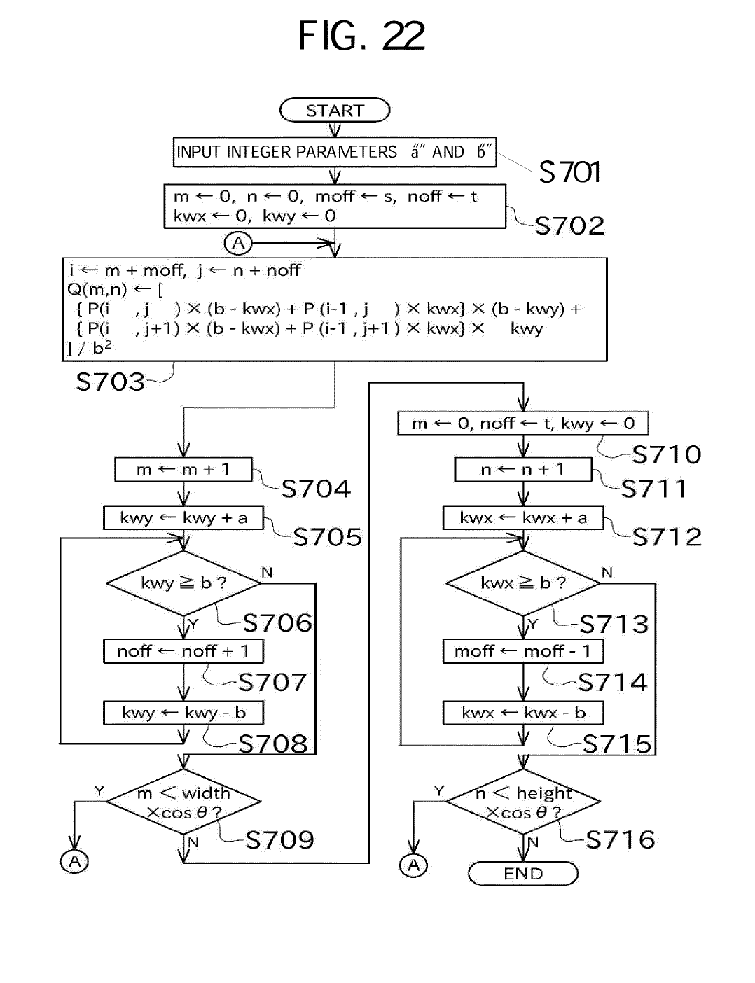

Next, the image rotating process executed through the extraction rotation process unit 90 will be described in detail with reference to the flowchart of FIG. 22.

When the flow of FIG. 22 is started, the extraction rotation process unit 90 first acquires two inclination integer parameters from the difference of the x-coordinates and the difference of the y-coordinates of the two vertexes 14a and 14b of the extraction area 14, and input the acquired parameters as the first integer parameter “a” and the second integer parameter “b” (S701).

Then, an initialization process of variables is performed (S702). In the initialization process, the x-coordinate “m” and the y-coordinate “n” of the target pixel of the rotated image is reset to zero. Further, as for an x-direction offset value “moff” and a y-direction offset value “noff”, the x-coordinate (s) and the y-coordinate (t) of the vertex 14a positioned at the upper left of the extraction area 14 of FIG. 21 are set as initial values. The x-direction offset value “moff” and the y-direction offset value “noff” are used to calculate the position of the corresponding target pixel (the original image pixel that corresponds to the target pixel). Further, the x-direction weighting factor “kwx” and the y-direction weighting factor “kwy”, which are used for the two-dimensional interpolation, are initialized to zero. Each of the variables “m”, “n”, “moff”, “noff”, “kwx”, and “kwy” is an integer variable.

Then, the pixel value “Q(m, n)” of the target pixel (m, n) of the rotated image is calculated (S703). In this process, firstly, the position (i, j) of the corresponding target pixel of the original image is calculated. The x-coordinate “i” of the corresponding target pixel can be acquired by adding the offset value “moff” to the x-coordinate “m” of the target pixel of the rotated image (i=m+moff). Similarly, the y-coordinate “j” of the corresponding target pixel can be acquired by adding the offset value “noff” to the y-coordinate “n” of the target pixel of the rotated image (j=n+noff).

Each time the target pixel of the rotated image moves by “b/a” pixels in the y-direction, one is subtracted from the offset value “moff” (S714). Each time the target pixel of the rotated image moves by “b/a” pixels in the x-direction, one is added to the offset value “noff” (S707). These addition/subtraction processes of the offset values will be described later.

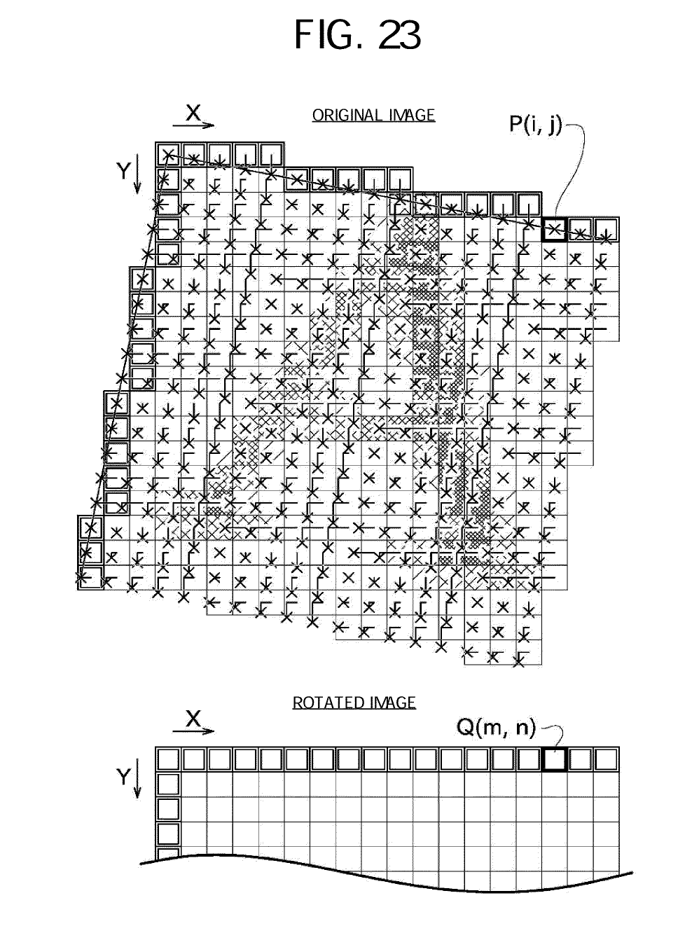

FIG. 23 illustrates a correspondence between the target pixel of the rotated image and the corresponding target pixel of the original image represented when the inclination parameters “a=1” and “b=5” acquired in the example of FIG. 21 are input as the first integer parameter and the second integer parameter into the extraction rotation process unit 90.

Assuming that the first row and first column of the rotated image are the target pixels, FIG. 23 illustrates the target pixels and the corresponding target pixels of the original image with the grids surrounded by double-lines. As illustrated in the upper drawing of FIG. 23, each time the target pixel of the rotated image moves by five pixels (i.e., by “b/a” pixels) in the x-direction, the corresponding target pixel of the original image is displaced by one pixel in the y-direction. Each time the target pixel of the rotated image moves by five pixels in the y-direction, the corresponding target pixel of the original image is displaced by one pixel in the x-direction.

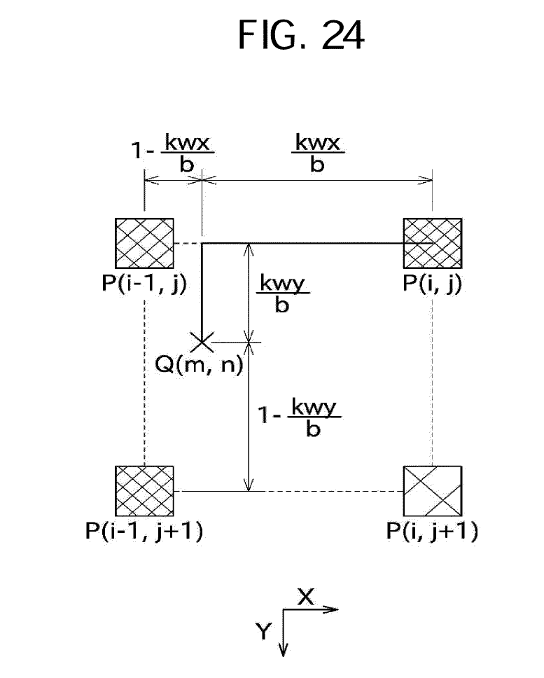

Next, the pixel value “Q(m, n)” of the target pixel of the rotated image is acquired through two-dimensional linear interpolation. As illustrated in FIG. 24, the two-dimensional linear interpolation uses four pixels: the corresponding target pixel (i, j) of the original image; the pixel (i−1, j) arranged next to the corresponding target pixel in the x-direction; the pixel (i, j+1) arranged next to the corresponding target pixel in the y-direction; and the pixel (i−1, j+1) arranged obliquely next to the corresponding target pixel. Based on each pixel value of these four pixels, that is, a pixel value P(i, j), a pixel value P(i−1, j), a pixel value P(i, j+1), and a pixel value P(i−1, j+1), by performing the linear interpolation by a ratio “kwx/b” acquired by dividing the x-direction weighting factor “kwx” by the second integer parameter “b”, and a ratio “kwy/b” acquired by dividing the y-direction weighting factor “kwy” by the second integer parameter “b”, the pixel value “Q(m, n)” of the target pixel (m, n) of the rotated image is acquired.

Each time the target pixel of the rotated image moves by one pixel in the y-direction, the first integer parameter “a” is added to the x-direction weighting factor “kwx” (S712 of FIG. 22). Each time the target pixel of the rotated image moves by one pixel in the x-direction, the first integer parameter “a” is added to the y-direction weighting factor “kwy” (S705). The addition process of the weighting factor will be described later.

S703 of FIG. 22 represents the formula regarding the pixel value “Q (m, n)” of the target pixel described in the schematic diagram of FIG. 24. In the formula, the division by the second integer parameter “b” is outside the square brackets. Thus, the division process, which requires a substantial calculation cost and time, can be performed by one division by a square of the second integer parameter (“b²”), thereby increasing the speed of the calculation process.

After the process (two-dimensional interpolation step) of acquiring the pixel value of S703 is completed, one is added to the x-coordinate “m” of the target pixel (S704). This process corresponds to a process of moving the target pixel (m, n) of the rotated image by one pixel in the x-direction.

Next, the first integer parameter “a” is added to the y-direction weighting factor “kwy” (S705). Then, it is determined whether the y-direction weighting factor “kwy” after the addition is more than or equal to the second integer parameter “b” or not (S706). When the y-direction weighting factor “kwy” after the addition is more than or equal to the second integer parameter “b”, one is added to the y-direction offset value “noff” (S707), and the second integer parameter “b” is subtracted from the y-direction weighting factor “kwy” (S708). Then, the process returns to S706.

When the y-direction weighting factor “kwy” is below the second integer parameter “b”, the process proceeds to S709, where it is determined whether or not the x-coordinate “m” of the target pixel of the rotated image is below a value acquired by multiplying the width of the rotated image by a cosine value (“cos θ”) of the inclination angle of the original document. When the x-coordinate “m” is below “width×cos θ”, the process returns to S703.

By the above-described flow, while changing the x-coordinate “m” of the target pixel (m, n) of the rotated image one by one from zero to “width×cos θ−1”, the process of calculating the pixel value “Q(m, n)” is repeated. Since “a” is added to the y-direction weighting factor “kwy” each time the x-coordinate “m” is changed by one (S705), in the two-dimensional interpolation performed at the time of calculating the pixel value “Q(m, n)”, a weight with respect to the two lower-side pixel values “P(i, j+1)” and “P(i−1, j+1)” is increased. The weight change ratio with respect to each time “m” is changed by one matches the value acquired by dividing “a” by “b”. Further, when the y-direction weighting factor “kwy” becomes more than or equal to “b”, one is added to the y-direction offset value “noff”, meaning that the corresponding target pixel (i, j) of the original image is displaced by one pixel in the y-direction.

When it is determined in S709 that the x-coordinate “m” of the target pixel is more than or equal to “width×cos θ”, each of the x-coordinate “m”, the y-direction offset value “noff”, and the y-direction weighting factor “kwy” is reset to zero (S710). More specifically, the value of the x-coordinate “m” is reset to zero, the y-direction weighting factor “kwy” is reset to zero, and the y-coordinate (t) of the vertex 14a positioned at the upper left of the extraction area 14 is set as the y-direction offset value “noff”. Next, one is added to the y-coordinate “n” of the target pixel (S711). This process corresponds to a process of moving the target pixel (m, n) of the rotated image by one pixel in the y-direction.

Next, the first integer parameter “a” is added to the x-direction weighting factor “kwx” (S712). Then, it is determined whether or not the x-direction weighting factor “kwx” after the addition is more than or equal to the second integer parameter “b” (S713). When the x-direction weighting factor “kwx” after the addition is more than or equal to the second integer parameter “b”, one is subtracted from the x-direction offset value “moff” (S714), and the second integer parameter “b” is subtracted from the x-direction weighting factor “kwx” (S715). Then, the process returns to S713.

When the x-direction weighting factor “kwx” is below the second integer parameter “b”, the process proceeds to S716, where it is determined whether or not the y-coordinate “n” of the target pixel of the rotated image is below a value acquired by multiplying the height of the rotated image by the cosine value (cos θ) of the inclination angle of the original document. When the y-coordinate “n” is below “height×cos θ”, the process returns to S703. When the y-coordinate “n” is more than or equal to “height×cos θ”, it means that the calculation of the pixel values of the target pixels is completed, and the process is ended.

By the above flow, while changing the y-coordinate “n” of the target pixel (m, n) of the rotated image one by one from zero to “height×cos θ−1”, the process of calculating the pixel value “Q(m, n)” is repeated. Since “a” is added to the x-direction weighting factor “kwx” each time the y-coordinate “n” is changed by one, in the two-dimensional interpolation performed at the time of calculating the pixel value “Q(m, n)”, a weight with respect to the two left-side pixel values “P(i−1, j)” and “P(i−1, j+1)” of FIG. 24 is increased. The weight change ratio with respect to each time “n” is changed by one matches the value acquired by dividing “a” by “b”. Further, when the x-direction weighting factor “kwx” becomes more than or equal to “b”, one is subtracted from the x-direction offset value “moff”, meaning that the corresponding target pixel (i, j) of the original image is displaced by one pixel in the x-direction.

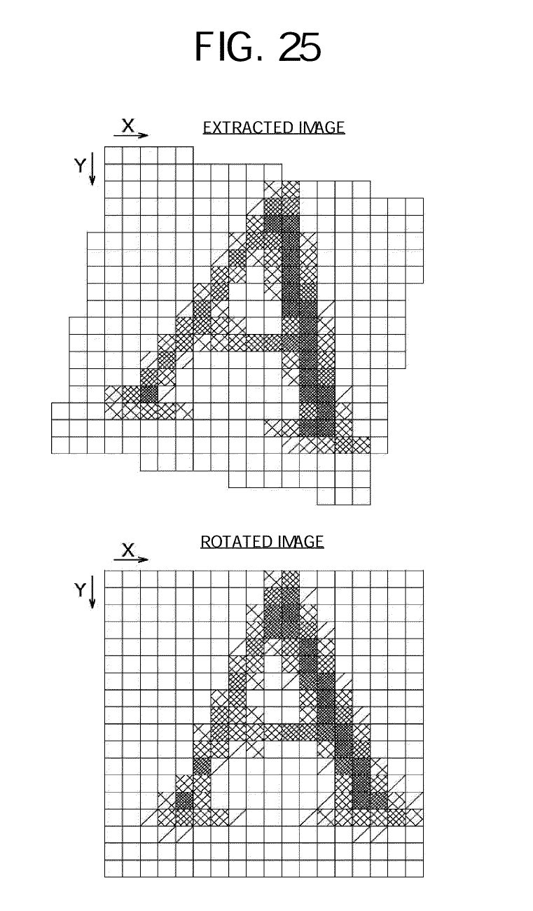

Thus, by performing the rotating process on a raster image of the original image illustrated in the upper drawing of FIG. 25, the rotated image illustrated in the lower drawing can be acquired. In the two-dimensional interpolation process (S703) of the flow of FIG. 22, the formula inside the square brackets can be implemented by the addition and multiplication of integers, and the pixel value “Q (m, n)” of the target pixel can be acquired by performing only one division (division by the square of integer “b”, i.e., division by “b²”). The calculations of the weighting factors (S705, S708, S712, and S715) can be implemented by the addition/subtraction processes of integers, and the determinations (S706 and S713) whether or not to offset the position of the corresponding target pixel can be implemented by a process of comparison between integers. Thus, the calculation cost can be substantially reduced, and the period of time required for the processes can also be reduced.

FIGS. 22 and 25 illustrate a situation in which the image is rotated in a counterclockwise direction. However, it should be noted that the image may also be rotated in a clockwise direction. Such a process may be performed by changing from “−1” to “+1” and from “+1” to “−1” in the processes of S703, S707, and S714 of the flowchart of FIG. 22.

In order to simplify the description, a relatively small image of 18 pixels in height by 18 pixels in width is used in FIGS. 23 and 25, however, the above-described rotating process of the present preferred embodiment is actually performed on the image extracted from the image data scanned through the scanner unit 21 based on the extraction area 14. After the above-described rotating process, a process of filling a portion that corresponds to the edge portion of the extraction area 14 in white may be performed. In this masking process, the boundary of the edge of the original document can be prevented from appearing on the image, and thus a preferable scanned image can be acquired.

Further, FIGS. 23 and 25 illustrate an example of a gray scale image, however, the rotating process of the extraction rotation process unit 90 can be applied to the rotation of a color image by performing a process similar to the above with respect to the tone of each color of RGB. When rotating the color image, it is preferable that after a weighting factor common to the three components is generated with respect to each pixel, the interpolation calculation is sequentially performed with respect to each color component. In other words, it is preferable to select a color component with respect to each pixel. Thus, the process of calculating the weighting factor can be commoditized among the color components, thereby reducing the period of time required for the processes.

As described above, the automatic image acquiring unit 95 of the image scanner apparatus 101 of the present preferred embodiment includes the feature point detecting unit 72, the inclination calculating unit 74, the feature point rotation calculating unit 81, and the rectangular area calculating unit 82. The feature point detecting unit 72 preferably detects a plurality of feature points of the original document outline from the image data acquired by scanning the original document through the scanner unit 21. The inclination calculating unit 74 preferably calculates the values regarding the original document inclination. The feature point rotation calculating unit 81 calculates the positions of the rotated feature points 10q acquired by rotating the plurality of feature points 10p detected through the feature point detecting unit 72, around the prescribed center point 13 by the inclination angle “θ” in the direction for correcting the original document inclination. The rectangular area calculating unit 82 calculates the non-inclined rectangular area 11 having the outline that is disposed in the vicinity of the rotated feature points 10q.

The rectangular area 11 including the original document portion of the inclination-corrected original document can be properly set based on the shape and the inclination of the original document. Accordingly, it is preferably used in a process of automatically recognizing the size of the original document, etc. Moreover, since the rectangular area 11 is set in accordance with the feature points of the outline of the original document, a proper rectangular area 11 can be set with respect to any original document of various shapes including a non-square shape. Further, the rectangular area 11 of the original document portion can be determined by using only the positions of the rotated feature points, without performing the rotating process on the entire image data. Accordingly, the calculation cost can be substantially reduced, and the period of time required for the processes can also be reduced. Furthermore, since the rectangular area 11 can be acquired in a non-inclined state, the rectangular area 11 can be handled easily as data, and the calculation can be simplified.

In the automatic image acquiring unit 95 of the present preferred embodiment, when the original document includes four sides as illustrated in FIG. 12, for example, the feature point detecting unit 72 detects feature points such that each of the four sides includes any of the feature points.

Thus, the rectangular area including the original document portion can be easily calculated and determined from the positions of the detected feature points.

In the automatic image acquiring unit 95 of the present preferred embodiment, the feature point detecting unit 72 detects the parallel or substantially parallel side from the outline of the original document, and acquires the feature points based on the detection result.

Thus, the feature points can be calculated through a more simple process than a process of detecting a corner portion, for example.

In the automatic image acquiring unit 95 of the present preferred embodiment, as illustrated in FIG. 12, the inclination calculating unit 74 preferably calculates the values regarding the original document inclination based on the positions of at least two feature points selected from the feature points detected through the feature point detecting unit 72.

Thus, the feature points can be used in the inclination detection, which thereby improves efficiency of the processes and increases the speed of the processes.

The automatic image acquiring unit 95 of the present preferred embodiment includes the size information determining unit 83 arranged to determine the size information based on the size of the rectangular area 11.

Therefore, when only the original document portion is extracted in the image data, the size of the output destination, for example, can be automatically determined properly. Moreover, when implementing the copying function, for example, the image data can be directly used as print data, which thereby can omit a special process at the time of printing.

In the automatic image acquiring unit 95 of the present preferred embodiment, the size information determining unit 83 preferably determines the size information by selecting, from a plurality of format sizes, such as A4 size and a B5 size etc., a format size that is the closest to the rectangular area 11 in size.

Thus, the area of the original document portion can be extracted from the image data in accordance with a commonly-used format size, which is convenient. Moreover, since the format size that is the closest to the rectangular area 11 in size is selected, an appropriate size can be selected in view of the size of the original document size. Further, even when a slight error occurs in the position, etc., of the calculated feature point, the size information can be prevented from being influenced by such errors. Accordingly, when a plurality of original documents of the same size is scanned, the output size can be prevented from being different from one another with respect to each sheet.

The size information determining unit 83 may determine the size information by selecting, from the predetermined format sizes, the smallest format size that can include the rectangular area 11.

In such a case, the area of the original document portion can be extracted from the image data in accordance with a common format size, which is convenient. Since the smallest format size that can include the rectangular area 11 is selected, an appropriate size can be selected in view of the size of the original document portion, and the original document portion can be reliably prevented from being (partially) cut from the extracted image data.

The automatic image acquiring unit 95 of the present preferred embodiment includes the target area determining unit 84, the extraction area calculating unit 85, and the extraction rotation process unit 90. The target area determining unit 84 determines the position of the non-inclined rectangular original document target area 12 having the size corresponding to the size information such that at least one portion of the original document target area 12 overlaps with the rectangular area 11. The extraction area calculating unit 85 calculates the extraction area 14 of the image data by rotating the original document target area 12 around the center point 13 by the inclination angle θ of the original document. The extraction rotation process unit 90 extracts the extraction area 14 from the image data and acquires the image data that corresponds to the original document target area 12 by performing the rotating process in order to correct the original document inclination.

Thus, the original document portion of a proper size of the image data can be extracted, and the original document inclination can be corrected so as to acquire a preferred scan image. Since the original document target area 12 can be acquired with having the rectangular shape and having no inclination similarly to the rectangular area 11, the calculation can be simplified, and the processes can be performed at high speed. Further, the inclination correcting process and the extracting process can be simultaneously performed.

In the automatic image acquiring unit 95 of the preferred embodiment, the target area determining unit 84 determines the position of the original document target area 12 such that the center of the original document target area 12 matches to the center of the rectangular area 11.

Thus, since the original document portion is disposed at the center position of the acquired image data, the usefulness of the image data can be improved. For example, assuming that the original document portion is disposed at the edge of the image data, when printing the image data through a printer etc., the original document portion may overlap with a non-printable area, which is an edge portion of a sheet of paper, and may be printed in a cut state. With the above-described configuration, since the original document portion is disposed at the center position of the image data, the original document portion may rarely be printed in a cut state at the time of printing.

In the automatic image acquiring unit 95 of the present preferred embodiment, the extraction rotation process unit 90 performs a filling process with prescribed color on a portion that corresponds to the edge of the rectangular area 11.

Thus, even when the original document edge appears in a framed shape at the edge portion of the rectangular area 11 of the image data, the edge can be removed in the filling process, and thus, an automatic frame removing function can be implemented.

Further, the image scanner apparatus 101 of the present preferred embodiment includes the image scanning unit 115 arranged to acquire image data by scanning an original document, and the image data can be processed through the automatic image acquiring unit 95.

Thus, based on the shape and inclination of the scanned original document, the rectangular area including the original document portion of the image data in the case where the original document inclination is corrected can be properly set. Accordingly, it is preferable in the process of automatically recognizing the size etc. of the original document and in the process of determining the output image size, or the like.

In the present preferred embodiment, the data correction unit 65, the inclination detecting unit 70, the image extraction determining unit 80, the extraction rotation process unit 90, and the code converting unit 45, or the like, are implemented preferably by using hardware such as an ASIC and an FPGA. However, each of these units may be implemented through a combination of the CPU 41 and programs installed through a suitable recording medium, or the like.

In such a case, the program preferably includes a feature point detecting step, an inclination calculating step, a feature point rotation calculating step, and a rectangular area calculating step. In the feature point detecting step, a plurality of feature points of an original document outline is detected from image data acquired by scanning an original document. In the inclination calculating step, values regarding an original document inclination are calculated. In the feature point rotation calculating step, the plurality of feature points detected through the feature point detecting unit is rotated around a prescribed center point by an inclination angle in a direction in which the original document inclination is corrected, and positions of the rotated feature points are calculated. In the rectangular area calculating step, based on the positions of the rotated feature points, a rectangular area having no inclination and an outline that is disposed in the vicinity of the rotated feature points is calculated.

With this configuration, similarly to the above, based on the shape and the inclination of the original document portion of the image data, the rectangular area including the original document portion in the case where the original document inclination is corrected can be properly determined.

The preferred embodiments of the present invention have been described, but the above-described configuration may be modified as follows, for example.

In the process of S102 of FIG. 3, the original document pixel and the background pixel are detected by using the difference of luminance between the white color of the pressing pad 121 and the pressing member 122 and the white color of the original document. However, other methods can be used to detect the original document pixel and the background pixel. For example, a yellow platen sheet may be attached to the pressing pad 121 and to the pressing member 122. In such a case, a Cb value, which is a parameter regarding colors, is calculated from input RGB value by using a well-known expression, and by comparing the Cb value with a prescribed threshold value, the original document pixel and the background value can be detected.

Alternatively, by attaching a black platen sheet to the pressing pad 121 and the pressing member 122, and by determining black pixels scanned at the edge portion side of the main scanning direction as background pixels, the original document and the background can be identified.

Alternatively, an original document may be placed on the platen glass 102 of the flat bed unit and scanned in a state in which the original document table cover 104 is open. In this case, the reflection light is not detected in an area on which the original document is not disposed, and the area is detected as black pixels. Thus, the pixels detected as black on both sides of a line can be recognized as background pixels. More specifically, a suitable sensor for detecting the opening and closing of the original document table cover 104 may be provided to the image scanner apparatus 101, and the above-described process may be performed when the sensor detects that the original document table cover 104 is open, for example.

The process of S104 may be modified such that a right edge pixel on a line of the left-hand corner portion and a left edge pixel on a line of the right-hand corner portion, for example, may be detected as feature points in addition to the four corner portions and the parallel or substantially parallel side, or at least three points on the parallel or substantially parallel side may be detected. It is preferable in that the difference between the rectangular area and the original document area can be reduced by increasing the number of feature points.

In the parallel or substantially parallel side detecting flow of FIG. 9, instead of detecting the right and left parallel or substantially parallel sides from the original document outline, or in addition to such detection, a parallel or substantially parallel side that appears at the leading end or the trailing end of the original document may be detected in order to detect feature points from a determination result. In such a case, the process may be performed preferably after one sheet of image data is stored in the suitable memory.

Instead of determining the rectangular area 11 such that the rectangular area 11 includes the rotated feature points 10q as illustrated in FIG. 18, the rectangular area 11 may be determined such that the rectangular area includes an area that is slightly inside the rotated feature points 10q, for example. That is, the rectangular area 11 may be determined such that the rectangular area 11 covers in substance the original document area.

When determining the original document target area 12 including the rectangular area 11, as illustrated in FIG. 18, the center of the original document target area 12 may not necessarily match to the center of the rectangular area 11. For example, the original document target area 12 may be determined such that one side (or corner) thereof matches to a side (corner) of the rectangular area 11.

The inclination calculating unit 74 is not limited to the configuration in which the values regarding the original document inclination are acquired from the positions of the feature points. For example, when a text document is scanned, the original document inclination can be calculated based on an inclination of an aligned character string. More specifically, an inclination angle of such a text document can be detected by repeating a process of counting a white line while image data is rotated by degrees, and then acquiring the angle having the largest number of white lines.

Instead of being used as a medium size used when the area extracted from the scanned data is output, or in addition to being used as such a medium size, the output size determined in S603 of FIG. 17 may be used as information for determining the original document size. In this case, a special sensor is not required, and the format size of the original document can be automatically detected.

The processes executed through the inclination detecting unit 70, the image extraction determining unit 80, and the extraction rotation process unit 90 are not limited to color images, and may be applied to monochrome images.

The processes executed through the inclination detecting unit 70, the image extraction determining unit 80, and the extraction rotation process unit 90 are not limited to the image scanner apparatus 101, and may be applied to other image scanning apparatuses, such as a copier, a facsimile machine, a Multi Function Peripheral, and an OCR, or other similar apparatuses.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. An image processing apparatus comprising:
a feature point detecting unit arranged to detect a plurality of feature points of an original document outline from image data acquired by scanning an original document;
an inclination calculating unit arranged to calculate values regarding an original document inclination;
a feature point rotation calculating unit arranged to calculate positions of rotated feature points acquired by rotating the plurality of feature points detected by the feature point detecting unit around a center point by an inclination angle in a direction in which the original document inclination is corrected; and
a rectangular area calculating unit arranged to calculate a non-inclined rectangular area having an outline that is disposed in the vicinity of the rotated feature points based on the positions of the rotated feature points.

2. The image processing apparatus according to claim 1, wherein the feature points detected by the feature point detecting unit include a plurality of points and at least one of the plurality of points is individually disposed on each of four sides of the original document outline.

3. The image processing apparatus according to claim 2, wherein the feature point detecting unit is arranged to detect a substantially parallel line or parallel line from the original document outline and then acquire the feature point from a detection result.

4. The image processing apparatus according to claim 1, wherein the inclination calculating unit is arranged to calculate the values regarding the original document inclination from positions of at least two feature points selected from the feature points detected by the feature point detecting unit.

5. The image processing apparatus according to claim 1, further comprising a size information determining unit arranged to determine size information based on a size of the rectangular area.

6. The image processing apparatus according to claim 5, wherein the size information determining unit is arranged to determine the size information by selecting a format size that is the closest in size to the size of the rectangular area from a plurality of predetermined format sizes.

7. The image processing apparatus according to claim 5, wherein the size information determining unit is arranged to determine the size information by selecting the smallest format size that can include the rectangular area from the predetermined format sizes.

8. The image processing apparatus according to claim 5, further comprising:
a target area determining unit arranged to determine a position of a non-inclined rectangular original document target area having a size that corresponds to the size information such that at least one portion of the original document target area overlaps with the rectangular area;
an extraction area calculating unit arranged to calculate an extraction area of the image data by rotating the original document target area around the center point by the inclination angle of the original document; and
an extraction rotation process unit arranged to extract a portion of the extraction area from the image data, and to acquire image data that corresponds to the original document target area by performing a rotation process to correct the original document inclination.

9. The image processing apparatus according to claim 8, wherein the target area determining unit is arranged to determine the position of the original document target area such that a center of the original document target area matches to a center of the rectangular area.

10. The image processing apparatus according to claim 8, wherein the extraction rotation process unit is arranged to perform a filling process with a prescribed color on a portion that corresponds to an edge of the rectangular area.

11. An image scanning apparatus including the image processing apparatus of claim 1, the image scanning apparatus comprising:
an image scanning unit arranged to acquire image data by scanning an original document; wherein
the image data is processed by the image processing apparatus.

12. An image processing method comprising:
a feature point detecting step arranged to detect a plurality of feature points of an original document outline from image data acquired by scanning an original document;
an inclination calculating step arranged to calculate values of an original document inclination;
a feature point rotation calculating step arranged to calculate positions of rotated feature points acquired by rotating the plurality of feature points detected by the feature point detecting unit around a center point by an inclination angle in a direction in which the original document inclination is corrected; and
a rectangular area calculating step arranged to calculate a non-inclined rectangular area having an outline that is disposed in the vicinity of the rotated feature points, based on the positions of the rotated feature points.

13. The image processing method according to claim 12, wherein the feature points detected in the feature point detecting step include a plurality of points, and at least one of the plurality of points is individually disposed on each of four sides of the original document outline.

14. The image processing method according to claim 13, wherein a substantially parallel line is detected from the original document outline and the feature point is acquired from a detection result in the feature point detecting step.

15. The image processing method according to claim 12, wherein the values regarding the original document inclination are calculated from positions of at least two feature points selected from the feature points detected in the feature point detecting step in the inclination calculating step.

16. The image processing method according to claim 12, further comprising a size information determining step arranged to determine size information based on a size of the rectangular area.

17. The image processing method according to claim 16, wherein the size information is determined by selecting a format size that is closest in size to the size of the rectangular area from a plurality of predetermined format sizes in the size information determining step.

18. The image processing method according to claim 16, wherein the size information is determined by selecting the smallest format size that can include the rectangular area from the predetermined format sizes in the size information determining step.

19. The image processing method according to claim 16, further comprising:
a target area determining step arranged to determine a position of a non-inclined rectangular original document target area having a size that corresponds to the size information such that at least one portion of the original document target area overlaps with the rectangular area;
an extraction area calculating step arranged to calculate an extraction area of the image data by rotating the original document target area around the center point by the inclination angle of the original document; and
an extraction rotation processing step arranged to acquire image data that corresponds to the original document target area by extracting a portion of the extraction area from the image data and then performing a rotation process for correcting the original document inclination.

20. The image processing method according to claim 19, wherein the position of the original document target area is determined such that a center of the original document target area matches a center of the rectangular area in the target area determining step.
